(19) United States
(12) Patent Application Publication
(10) Pub. No.: US 2022/0302838 A1
(43) Pub. Date: Sep. 22, 2022

(54) VOLTAGE TRANSIENT SUPPRESSION IN A SWITCHED MODE POWER SUPPLY

(71) Applicant: Telefonaktiebolaget LM Ericsson (publ), Stockholm (SE)

(72) Inventors: Lackis Eleftheriadis, Gävle (SE); Conny Engelund, Kode (SE); Pål Frenger, Linköping (SE); Lars Tillquist, Gråbo (SE)

(21) Appl. No.: 17/619,060

(22) PCT Filed: Jun. 14, 2019
(86) PCT No.: PCT/EP2019/065696

§ 371 Date: Dec. 14, 2021

(51) Int. Cl. H02M 3/158; H02M 1/00; H02M 3/156

(52) U.S. Cl. CPC H02M 3/158; H02M 1/0025; H02M 1/0019; H02M 3/1566

(57) ABSTRACT

A switched mode power supply, SMPS, which supplies an output voltage to a load, wherein a load current drawn by the load varies over time in accordance with load scheduling information. The SMPS comprises a voltage conversion circuit which converts an input voltage of the SMPS to the output voltage, and a controller which generates a control signal (S_{SW}) based on a feedback signal indicative of the output voltage, and controls the voltage conversion circuit using the control signal to regulate the output voltage. The controller further generates a modified control signal (S′_{SW}) using an indication of a change in the load current that is based on the load scheduling information, and controls the voltage conversion circuit using the modified control signal before the change in the load current occurs to suppress a voltage transient in the output voltage caused by the load current change.

### TECHNICAL FIELD

The present invention relates to the field of switched mode power supplies and, more specifically, to the suppression of voltage transients and ringing which occur in an output voltage of a switched mode power supply.

### BACKGROUND

The switched mode power supply (SMPS) is a well-known type of power converter having a diverse range of applications by virtue of its small size and weight and high efficiency, for example in servers, personal computers and portable electronic devices such as cell phones. A SMPS achieves these advantages by switching one or more switching devices such as power MOSFETs at a high frequency (usually tens to hundreds of kHz), with the frequency or duty cycle of the switching being adjusted using a feedback signal to convert an input voltage to a desired output voltage. A SMPS may take the form of a rectifier (AC/DC converter), a DC/DC converter, a frequency changer (AC/AC) or an inverter (DC/AC).

In many SMPS applications, the SMPS output voltage to be supplied to a load circuit must be regulated to remain within a narrow voltage band. This output voltage regulation may be achieved, for example, by providing a feedback voltage indicative of the SMPS output voltage to a pulse width modulation (PWM) controller which monitors the feedback signal and adjusts the switching duty cycle of the SMPS switching element in order to maintain the output voltage a predetermined value.

Although closed loop control of the SMPS may allow the SMPS output voltage to be regulated to a desired level, the feedback circuit may be slow to respond to rapid changes in the load current drawn from the SMPS by the load circuit. This can result in voltage transients appearing in the SMPS output voltage.

The SMPS may be unable to react instantly to changes in the load current for a number of different reasons, for example because the current flowing through an inductor element, which may, for example, form part of an output filter of an SMPS or a transformer forming part of the SMPS, cannot change instantly. When a load current increase occurs, a finite amount of time may be needed for the inductor to accommodate the increased load current, the amount of time depending on the size of the load current increase. During normal, feedback-controlled operation of the SMPS, a dip in the SMPS output voltage that occurs in response to the load increase is detected by the feedback control loop of the SMPS, and the pulse width modulator regulating the output voltage of the SMPS increases the duty cycle of the switching signal to increase the inductor current. However, until the inductor current slews to the new load current, one or more capacitors that may be provided at the output of the SMPS must discharge to initially satisfy the changed load current requirement, causing a dip in the output voltage of the SMPS. The magnitude of the output voltage dip depends directly on the size of the output capacitor(s), the size of the load change, and the SMPS feedback loop bandwidth. Similarly, the SMPS output voltage may similarly exhibit voltage spikes when the SMPS has an excess of energy following a rapid load decrease. That is, when the load current falls, the inductor element in the SMPS prevents an instant decrease in the inductor current, causing the additional current to charge the output capacitor(s) of the SMPS. This additional charge causes a voltage spike in the SMPS output voltage.

A conventional approach to reducing the voltage dips and spikes that are caused by rapid load changes is to increase the size of the capacitor(s) at the output of the SMPS. For this purpose, electrolyte, polymer and tantalum capacitors are often used to reduce the voltage dip by acting as an energy reservoir for the transient load currents. However, these capacitors usually take up valuable space in the SMPS circuit, have a limited lifetime at high temperatures, and are costly. Therefore, the number of capacitors used is normally a trade-off between size, transient response and cost.

While the aforementioned voltage transients are caused by the inductor element of the SMPS, further voltage deviations may occur as a result of parasitic inductance and capacitance from the external circuitry connecting the SMPS to the load circuitry. For example, when the load current changes, the self-inductance of the cables or printed circuit board (PCB) traces on a PCB connecting the SMPS to the load circuit may result in an initial voltage deviation, while the cable resistance may cause an output voltage drop as the load current slews.

Furthermore, when the load circuitry is remote from the SMPS, rapid load changes may cause parasitic PCB trace inductance to resonate with stray capacitance on the PCB, resulting in a high-frequency ringing of the voltage signal measured at the input of the load circuit. This LC oscillation effect can be triggered by a sudden voltage change in the load circuitry (e.g. a supply voltage of an amplifier forming part of the load circuitry), which can cause these parasitic LC components to resonate at their characteristic frequency. Fundamentally, the LC oscillation is caused by a back-and-forth exchange of electrical energy between the effective circuit capacitance and inductance at the resonance frequency, with the amplitude of the oscillation decreasing over time as energy is gradually dissipated in the circuit.

Regardless of the specific application in which the SMPS is used, the aforementioned voltage transients and ringing can lead to a variety of problems. For example, the high-frequency ringing of the voltage at the input of the load circuit may propagate across the circuit board, contributing to circuit noise, and may additionally or alternatively cause unwanted buzzing or other sounds to the piezoelectric effect in any ceramic capacitors that may be present on the PCB. Furthermore, dissipation of the voltage transients through circuit heating, for example, may degrade the power efficiency of the SMPS.

### SUMMARY

In light of the above-mentioned problems, the present inventors have devised a way of preventing or reducing voltage transients in the output voltage of a SMPS, by using pre-information on load changes which are scheduled to occur.

The inventors have devised a switched mode power supply, SMPS, operable to supply an output voltage to a load, wherein an operating requirement of the load, comprising a load current drawn from the SMPS by the load or an operating voltage of the load, is scheduled to vary over time in accordance with scheduling information. The SMPS comprises a voltage conversion circuit having a switching element and configured to convert an input voltage applied to an input of the SMPS to the output voltage at an output of the SMPS by switching of the switching element, and a controller configured to generate a switching control signal based on a feedback signal that is indicative of the output voltage, and to control the switching of the switching element using the switching control signal so as to regulate the output voltage. The controller is further configured to generate a modified switching control signal using an indication of a change in the operating requirement that is based on the scheduling information, and to control the switching of the switching element using the modified switching control signal before the change in the operating requirement occurs so as to suppress a voltage transient in the output voltage caused by the change in the operating requirement.

### BRIEF DESCRIPTION OF THE DRAWINGS

Embodiments of the invention will now be explained in detail, by way of example only, with reference to the accompanying figures.

FIG. 1 is a schematic illustration of a switched mode power supply according to a first embodiment.

FIG. 2 shows an example of a hardware implementation of the controller shown in FIG. 1.

FIG. 3 illustrates an example implementation of the SMPS according to the first embodiment.

FIG. 4 illustrates a circuit arrangement by which the signal adjustment module 102-1 of the implementation of FIG. 3 may adjust the feedback signal S_{FB}.

FIG. 5A illustrates a first example variation of a scheduled load current to be drawn from the SMPS of the first embodiment by the load 120.

FIG. 5B is an example timing diagram for generating a modified switching control signal in the first embodiment, based on the first example variation of the scheduled load current illustrated in FIG. 5A.

FIG. 6A illustrates a second example variation of a scheduled load current to be drawn from the SMPS of the first embodiment by the load 120.

FIG. 6B is an example timing diagram for generating a modified switching control signal in the first embodiment, based on the second example variation of the scheduled load current illustrated in FIG. 6A.

FIG. 7A illustrates a third example variation of a scheduled load current to be drawn from the SMPS of the first embodiment by the load 120.

FIG. 7B is an example timing diagram for generating a modified switching control signal in the first embodiment, based on the third example variation of the scheduled load current illustrated in FIG. 7A.

FIG. 8 illustrates an example implementation of the signal adjustment module 102-1 of the first embodiment.

FIG. 9 illustrates another example implementation of the signal adjustment module 102-1 of the first embodiment.

FIG. 10A illustrates a measured response of a conventional SMPS to a step change in the load current drawn from the SMPS by a load.

FIG. 10B illustrates a measured response of an SMPS according to an embodiment to a step change in the load current drawn from the SMPS by a load.

FIG. 11 illustrates an example implementation of the SMPS according to a second embodiment.

FIG. 12A illustrates a fourth example variation of a scheduled load current to be drawn from the SMPS of the second embodiment by the load 120.

FIG. 12B is an example timing diagram for generating a modified switching control signal in the second embodiment, based on the fourth example variation of the scheduled load current illustrated in FIG. 12A.

FIG. 13A illustrates a variation of the inductor current in an SMPS according to the second embodiment during operation of the SMPS in the first mode of operation described herein, and during subsequent sourcing and sinking of current to the output of the SMPS in the second mode of operation described herein.

FIG. 13B illustrates a second variation of the inductor current in an SMPS according to the second embodiment during operation of the SMPS in the first mode of operation described herein, and during subsequent sourcing and sinking of current to the output of the SMPS in the second mode of operation described herein.

FIG. 14 illustrates a network base station comprising the SMPS according to the second embodiment, which is arranged to supply power to an RF power amplifier.

FIG. 15 illustrates a comparison between the load transient response of a conventional SMPS and the load transient response of an SMPS according to an embodiment.

### DETAILED DESCRIPTION OF EMBODIMENTS

As will be explained in more detail below, when scheduling information that is indicative of an operating requirement of the load, for example a load current drawn from the SMPS by the load or an operating voltage of the load (e.g. a supply voltage that is supplied by the SMPS to the load) is available to the SMPS before the change in the operating requirement actually occurs, the SMPS can prevent or reduce the voltage transients discussed above through appropriate control of the SMPS. This control of the SMPS may be performed by generating a modified switching control signal based on the scheduled change in the operating requirement and controlling the switching of the SMPS based on the modified switching control signal before the change in the operating requirement occurs. By appropriately adjusting the switching operation of the SMPS before a change in the operating requirement occurs, the SMPS according to embodiments described herein may reduce or eliminate voltage transients and ringing in the output voltage of the SMPS.

### Embodiment 1

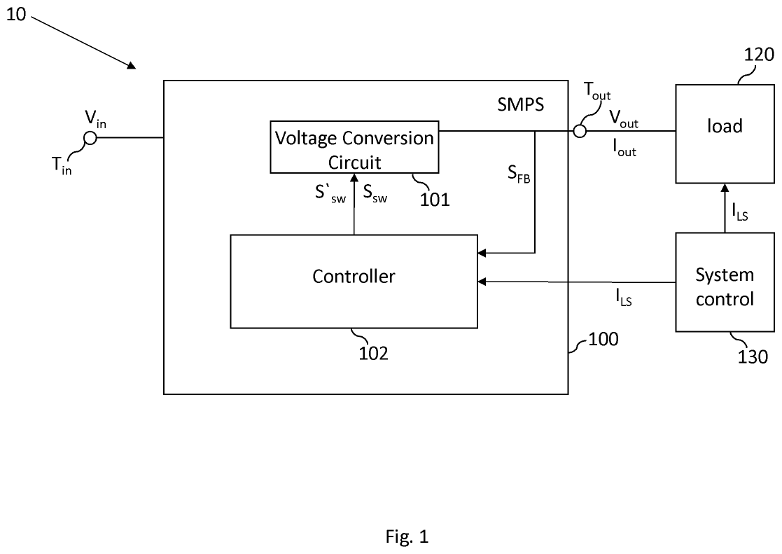

FIG. 1 illustrates a system 10 comprising an SMPS 100 according to a first embodiment. The SMPS 100 is operable to supply an output voltage Vₒᵤₜ to a load 120 forming part of the system 10, which is connected to the output terminal, Tₒᵤₜ, of the SMPS 100. An operating requirement of the load 120 is scheduled to vary over time in accordance with scheduling information. In the present embodiment, the load current Iₒᵤₜ drawn from the SMPS 100 by the load 120 (as an example of the operating requirement) is scheduled to vary over time in accordance with the scheduling information. The operating requirement of the load 120 may alternatively take the form of a supply voltage to be supplied to the load 120 by the SMPS 100 (or another operating voltage of the load 120, such as a bias voltage applied to a power amplifier in an example where the load 120 comprises the power amplifier), for example.

The system 10 further comprises a system control module 130, which provides the scheduling information to the SMPS 100. It should be noted that the system control module 130 need not be a stand-alone device, and could alternatively form part of the SMPS 100 or the load 120, for example. For instance, when the system 10 is part of a telecommunication system, the system control module 130 may form part of the radio unit or part of the baseband unit, depending on the radio access network architecture.

The SMPS 100 comprises a voltage conversion circuit 101 and a controller 102. The voltage conversion circuit 101 has at least one switching element and is configured to convert an input voltage Vᵢₙ, which is applied to an input terminal Tᵢₙ of the SMPS 100, to the output voltage Vₒᵤₜ of the SMPS 100 by switching of the least one switching element.

The switching element(s) is typically a power transistor (e.g. a power MOSFET), which is controlled by a switching control signal generated by the controller 102 to switch at a frequency that is typically high (e.g. tens to hundreds of kHz, or a few MHz) and with a duty cycle determined by the controller 102, so as to convert the input voltage Vᵢₙ to the output voltage Vₒᵤₜ.

The voltage conversion circuit 101 may, as in the present embodiment, be implemented to convert an input DC voltage to a (different) output DC voltage, although the voltage conversion circuit 101 may alternatively convert an AC voltage to a DC voltage (thus functioning as a rectifier), or an AC voltage to another AC voltage (functioning as a frequency changer) or a DC voltage to an AC voltage (functioning as a inverter).

The circuit topology of the voltage conversion circuit 101 is not limited, and may take one of many different forms known to those skilled in the art. For example, the voltage conversion circuit 101 may, as in the present embodiment, have a non-isolated typology (e.g. Buck or Boost), wherein an inductor is used instead of a transformer to provide an energy storage element in a flywheel circuit. Alternatively, in other embodiments, the voltage conversion circuit 101 may have an isolated typology (e.g. a Flyback topology), which includes an isolation transformer having a primary winding driven by a primary side circuit that can be powered by an AC or a DC source, as well as a second winding electromagnetically coupled to the primary winding, which is arranged to drive a secondary side circuit, typically comprising a rectifying network.

As the details of the suitable circuit topologies and other details of the voltage conversion circuit 101 (e.g. whether it is configured to be soft-switched or hard-switched) are well-known to those skilled in the art, they will not be described further here.

The controller 102 is configured to regulate the output voltage Vₒᵤₜ of the SMPS 100 by generating the switching control signal S_{SW} to control the switching of the switching element(s) based on a feedback signal S_{FB} that is indicative of the output voltage Vₒᵤₜ. The SMPS output voltage regulation is typically performed to compensate for fluctuations in the input voltage Vᵢₙ to the SMPS 100 or those caused by the internal impedance of the SMPS 100 when load current Iₒᵤₜ changes, for example.

The controller 102 is further operable to generate a modified switching control signal, S′_{SW}, using an indication of a change in the load current Iₒᵤₜ, the indication being based on the scheduling information (also referred to as load scheduling information, I_{LS}, in the present embodiment), and to begin controlling the switching of the switching element(s) using the modified switching control signal S′_{SW} before the change in the load current Iₒᵤₜ occurs (or at the same time the change occurs), so as to suppress (reduce or eliminate) a voltage transient in the output voltage Vₒᵤₜ caused by the change in the load current Iₒᵤₜ drawn from the SMPS 100 by the load 120. The suppression of the voltage transient may allow the size of any capacitors provided at the output of the SMPS 100 to be reduced, and may also allow unwanted sounds caused by load changes (e.g. via the piezoelectric effect in the capacitors or other component in the SMPS circuit that is connected to the output connector Tₒᵤₜ) to be reduced or altogether eliminated.

After controlling the switching of the switching element(s) using the modified switching control signal S′_{SW}, the controller 102 may control the switching of the switching element(s) using the switching control signal S_{SW}, thus reverting to using normal voltage regulation.

Thus, normal operation of the controller 102, during which the controller 102 regulates the output voltage Vₒᵤₜ using a switching control signal S_{SW} that is based on the feedback signal S_{FB}, may be interrupted by the controller 102 instead generating the modified switching control signal S′_{SW} that is based on both the feedback signal S_{FB} and the load scheduling information I_{LS}, in order to reduce or eliminate a voltage transient in the output voltage Vₒᵤₜ caused by the scheduled change in the load 200, with the normal output voltage regulation subsequently resuming.

In the present embodiment, the load scheduling information I_{LS} is indicative of a change in the magnitude of the load current Iₒᵤₜ which is scheduled to be drawn by the load 120 from the SMPS 100 but which has not yet been drawn. The load scheduling information I_{LS} is provided to the SMPS 100 periodically at regular intervals, although the load scheduling information I_{LS} may alternatively be provided to the SMPS 100 aperiodically. In some embodiments, the load scheduling information I_{LS} may be indicative of a sequence of changes in the magnitude of the load current Iₒᵤₜ.

In another embodiment, the load scheduling information I_{LS} may be indicative of a timing and a magnitude of the load current Iₒᵤₜ which is scheduled to be drawn by the load 120 from the SMPS 100. The load scheduling information I_{LS} may therefore comprise information indicative of at least one value of a load current Iₒᵤₜ which is scheduled to be drawn from the SMPS 100 by the load 120 but has not yet been drawn. The load scheduling information I_{LS} may provide information from which a scheduled variation over time of a plurality of the values of the load current Iₒᵤₜ, which are scheduled to be drawn from the SMPS 100 by the load 120 but have not yet been drawn, can be derived. The load scheduling information I_{LS} may, for example, comprise data defining a scheduled variation of the power required by the load 120, from which the scheduled variation of the load current can be calculated.

For example, the SMPS 100 may be configured to assesses the value(s) of load current Iₒᵤₜ indicated by the load scheduling information at respective timings (e.g. time slots) that are determined by a clock used by the SMPS 100, and the load scheduling information may comprise a sequence of values that are indicative of respective values of the load current Iₒᵤₜ to be drawn from the SMPS 100 by the load 120 at respective ones of the timings (e.g. in the respective time slots). The magnitude of each value may thus be indicative of the magnitude of the load current Iₒᵤₜ which is scheduled to be drawn by the SMPS 100, while the position of each value in the sequence of values may be indicative of the timing at which a load current of that value is to be drawn by the load 120. The SMPS 100 may therefore correlate the sequence of values to its own internal timing in order to determine the timing of any changes in the load current Iₒᵤₜ indicated by the sequence of values. The SMPS 100 may therefore determine the start timing for controlling of the switching element(s) using the modified switching control signal S′_{SW} before the change in the load current Iₒᵤₜ occurs. In an alternative embodiment, the load scheduling information may be provided in the form of a series of pairs of values, wherein each pair of values comprises a first value indicative of the magnitude of a load current Iₒᵤₜ which is scheduled to a drawn from the SMPS 100 (or a change in the magnitude of the load current Iₒᵤₜ), and a second value indicative of a time when the load current Iₒᵤₜ (or load current change) indicated by the first value is scheduled to occur.

The controller 102 may, in some embodiments, determine an indication of a forthcoming change in the load current Iₒᵤₜ from the load scheduling information I_{LS} by using a first value obtained from the load scheduling information that is indicative of a load current Iₒᵤₜ which has been drawn from the SMPS 100 by the load circuit 120, and a second value that is indicative of a scheduled load current Iₒᵤₜ which has not yet been drawn from the SMPS 100 by the load 120. Alternatively, the load current change may be determined using only scheduled values relating to future time instances, from which values of the load current to be drawn by the load 120 can be derived. As a further alternative, the controller 102 may determine the indication of the change in the load current Iₒᵤₜ based on the load scheduling information I_{LS} and a measurement indicative of a load current Iₒᵤₜ drawn from the SMPS 100 by the load 120. For example, the controller 102 may continuously perform measurements of the load current Iₒᵤₜ drawn from the SMPS by the load 120 and determine the change in the load current using the most recent measurement of the load current Iₒᵤₜ and a value indicative of a load current Iₒᵤₜ which is scheduled to be drawn from the SMPS 100 by the load 120.

It should be noted that, in some embodiments, the controller 102 may not calculate the change in the load current Iₒᵤₜ but could instead obtain load scheduling information I_{LS} in a form that directly indicates changes in the load current Iₒᵤₜ. For example, in some embodiments, the load scheduling information may comprise one or more values as noted above, with each value being indicative of a change in the value of the load current Iₒᵤₜ rather than of the value of the load current Iₒᵤₜ itself. For example, the load scheduling information may comprise a value defining a scheduled change in the power consumption on the load 120. The change in the load current Iₒᵤₜ indicated by each value may be relative to a load current Iₒᵤₜ already drawn from the SMPS 100 by the load 120, or it may be relative to a load current Iₒᵤₜ which is scheduled to be drawn and has not yet been drawn. Similarly, the earlier described variant wherein the load scheduling information I_{LS} comprises one or more pairs of values may be similarly adapted such that one value in each pair of values indicates a change in the load current Iₒᵤₜ.

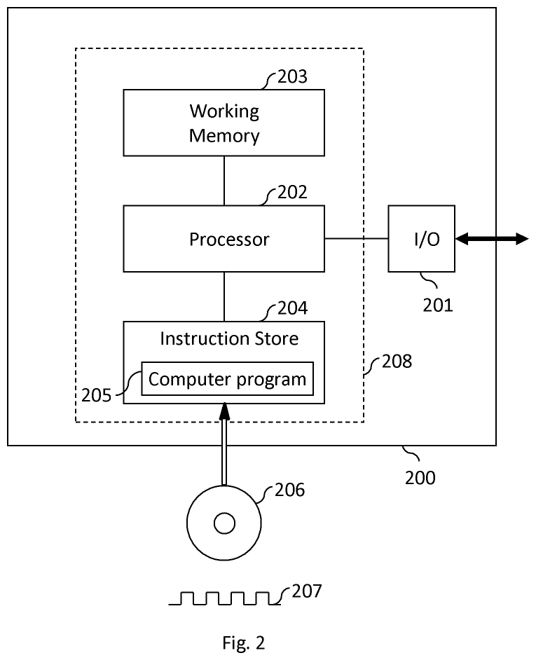

FIG. 2 shows an example implementation of the controller 102, in programmable signal processing hardware. The signal processing apparatus 200 shown in FIG. 2 comprises an input/output (I/O) section 201 for receiving the feedback signal S_{FB} from the voltage conversion circuit 101 and load scheduling information I_{LS} from system control module 130. The signal processing apparatus 200 further comprises a processor 202, a working memory 203 and an instruction store 204 storing a computer program 205 comprising computer-readable instructions which, when executed by the processor 202, cause the processor 202 to perform the processing operations hereinafter described to generate the switching control signal S_{SW} and the modified switching control signal S′_{SW} for controlling the switching the switching element(s) in the voltage conversion circuit 101. The instruction store 204 may comprise a ROM which is pre-loaded with the computer-readable instructions. Alternatively, the instruction store 204 may comprise a RAM or similar type of memory, and the computer-readable instructions can be input thereto from a computer program product, such as a computer-readable storage medium 206 such as a CD-ROM, etc. or a computer-readable signal 207 carrying the computer-readable instructions.

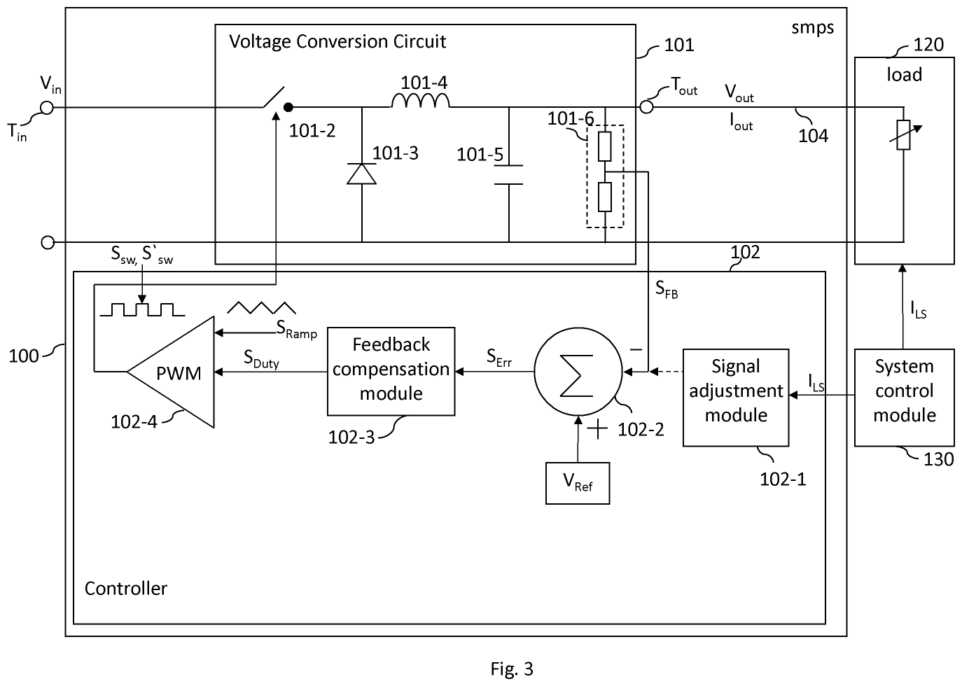

In the present embodiment, the combination 208 of the hardware components shown in FIG. 2, comprising the processor 202, the working memory 203 and the instruction store 204, is configured to implement the functionality of the controller 102, which will now be described in more detail with reference to FIG. 3.

FIG. 3 illustrates an example implementation of SMPS 100 according to the first embodiment. In the illustrated implementation, the voltage conversion circuit 101 is provided, by way of an example, in the form of a buck converter comprising a switching element 101-2, a diode 101-3, an inductor element 101-4, an output capacitor 101-5 and a feedback voltage divider 101-6, which are configured to provide the output voltage Vₒᵤₜ to an electrical connection (e.g. a conductive trace on a circuit board, a cable or other conductor) connecting the voltage conversion circuit 101 to the load 120.

The controller 102 may, as in the present embodiment, further comprise an error signal generation module 102-2 configured to generate an error signal S_{Err} by subtracting the feedback signal S_{FB} from a reference signal (reference voltage) V_{Ref}. It is noted, however, that the error signal generation module 102-2 may alternatively be configured to generate the error signal S_{Err} by subtracting the reference signal V_{Ref} from the feedback signal S_{FB}. The feedback signal S_{FB} is obtained via the voltage divider 101-6 and is thus indicative of the output voltage Vₒᵤₜ. The reference signal V_{Ref} may, as in the present embodiment, be adjustable in order to allow adjustment of the output voltage Vₒᵤₜ, or it may alternatively be non-adjustable (fixed).

The generated error signal S_{Err} is input to a feedback compensation module 102-3, which generates a duty cycle control signal S_{Duty} based on the error signal S_{Err}.

In the present embodiment, the feedback compensation module 102-3 employs proportional, integral and derivative, PID, control, and thus uses a set of P, I and D values to calculate the duty cycle control signal S_{Duty} on the basis of the error signal S_{Err}. However, the feedback compensation module 102-3 may, in other embodiments, apply another control law algorithm, such as PI, PD, P and I, etc. to generate the duty cycle control signal S_{Err} based on the error signal S_{Err}.

The controller 102 further comprises a switching signal generation module 102-4, which is configured to generate the switching control signals S_{SW} based on the duty cycle control signal S_{Duty}. The switching signal generation module 102-4 may, as in the present embodiment, provided in the form of a pulse width modulator (PWM), which compares the generated duty cycle control signal S_{Duty} with a periodic ramp signal S_{Ramp}, typically having a triangular waveform, and generates the switching control signal S_{SW} based on the comparison. Ways of implementing a PWM and the like will be familiar to those skilled in the art, so that further details thereof will not be provided here.

Although the embodiment in FIG. 3 is based on voltage mode control for regulation of the SMPS output voltage Vₒᵤₜ, the techniques described herein can alternatively be used in current mode control regulation, where a second loop feeding back inductor current flowing through the inductor element 101-4 of the SMPS 100 is used to derive the switching control signal S_{SW}. In current mode control regulation, the switching control signal S_{SW} would be generated based on the inductor current level and the duty cycle control signal S_{Duty} which is output by the feedback compensation module 123.

The controller 102 further comprises a signal adjustment module 102-1, which is configured to adjust the feedback signal S_{FB} based on the indication of the change in the load current Iₒᵤₜ determined using the load scheduling information I_{LS}, such that the switching signal generation module 102-4 generates the modified switching control signal S′_{SW}. It should be noted, however, that an adjustment of one or more of the reference signal V_{Ref}, the feedback signal S_{FB}, the error signal S_{Err} and the duty cycle control signal S_{Duty}, would similarly result in a modified switching control signal S′_{SW}. The signal adjustment module 102-1 may therefore more generally be configured to adjust one or more of the reference signal V_{Ref}, the feedback signal S_{FB}, the error signal V_{Err} and the duty cycle control signal S_{Duty} based on the indication of the change in the load current Iₒᵤₜ provided by the load scheduling information I_{LS}, such that the switching signal generation module 102-4 generates the modified switching control signal S′_{SW}. As a yet further alternative, the signal adjustment module 102-1 may generate the modified switching control signal S′_{SW} by adding a DC offset to the periodic reference signal S_{Ramp} used by the switching control signal generator 102-4 to generate the switching control signal. When the load scheduling information indicates a rising load step, the signal adjustment module 102-1 may add a positive DC offset to the periodic reference signal S_{Ramp} to increase the switching duty cycle before the load step occurs. Similarly, the signal adjustment module 102-1 may be configured to respond to a scheduled falling load step by decreasing the DC offset of the periodic reference signal S_{Ramp} in order to reduce the switching duty cycle.

The signal adjustment module 102-1 may, as in the present embodiment, generate a stimulus signal based on the indication of the change in the load current Iₒᵤₜ provided by the load scheduling information I_{LS}, and thus cause the switching signal generation module 102-4 to generate a modified switching control signal S′_{SW}. The signal adjustment module 102-1 may determine the characteristics of the stimulus signal to be generated, for example, one or more of its timing, waveform, magnitude and duration, based on the load current change indicated in the load scheduling information I_{LS}. For example, the stimulus signal may take the form of a voltage pulse, or a voltage whose magnitude is determined to vary so as to follow (i.e. be a scaled version of) the scheduled variation over time of the load current Iₒᵤₜ that is to be drawn from the SMPS 100 by the load 120. The signal adjustment module 102-1 of the present embodiment is configured to add the stimulus signal to the feedback signal S_{FB}. However, it should be noted that the signal adjustment module 102-1 could be configured to adjust the feedback signal S_{FB} in another way that does not require the generation and addition of a stimulus signal, for example by adjusting the configuration of the feedback voltage divider at the output of the SMPS 100 (e.g. a resistance of a variable resistor in the voltage divider) to directly obtain a modified feedback signal S′_{Fb}.

The signal adjustment module 102-1 may, in some embodiments, be configured to adjust one or more of the signals on which the switching control signal generated by the switching signal generation module 102-4 is based, irrespective of the size of load current changes determined using the load scheduling information I_{LS}. Thus, where the indication of the change in the load current indicates a scheduled increase (of any size) in the load current, the signal adjustment module 102-1 may adjust one or more of the reference signal, the feedback signal, the error signal and the duty cycle control signal so as to increase the switching duty cycle of the modified switching control signal S′_{SW} generated by the switching signal generation module 102-4. On the other hand, where the indication of the change in the load current indicates a scheduled decrease in the load current, the signal adjustment module 102-1 may adjust the one or more of the reference signal, the feedback signal, the error signal and the duty cycle control signal so as to decrease the switching duty cycle of the modified switching control signal S′_{SW}.

However, in the present embodiment, the controller 102 (in particular, the signal adjustment module 102-1 thereof) is operable to determine whether the indication of the change in the load current provided by the load scheduling information I_{LS} indicates a scheduled change in the load current Iₒᵤₜ which exceeds a first predetermined threshold, and the switching signal generation module 102-4 is operable to generate the modified switching control signal S′_{SW} and control the switching of the switching element 101-2 using the modified switching control signal S′_{SW} before the change in the load current Iₒᵤₜ occurs, only on the condition that the indication of the change in the load current provided by the load scheduling information I_{LS} is determined to indicate a scheduled change in the load current which exceeds the first predetermined threshold. Thus, scheduled changes in the load current that are small relative to the first predetermined threshold are effectively dealt with by conventional feedback voltage regulation, while larger changes that cannot be effectively suppressed by the feedback voltage regulation are handled by the controller 102 as described above, with the modified switching control signal S′_{SW} that are generated by the switching signal generation module 102-4 suppressing voltage transients or ringing on the power supply line with connects the SMPS 100 to the load 120.

More specifically, in the present example, when the signal adjustment module 102-1 determines that the load scheduling information I_{LS} indicates a scheduled increase in the load current Iₒᵤₜ which exceeds a first threshold value, the signal adjustment module 102-1 adjusts the feedback signal S_{FB} so that the switching signal generation module 102-4 generates a modified switching control signal S′_{SW} which causes the switching element 101-2 to switch with a higher duty cycle, before the increase in the load current Iₒᵤₜ occurs. In addition, when the signal adjustment module 102-1 determines that the load scheduling information I_{LS} indicates a scheduled decrease in the load current Iₒᵤₜ which exceeds a second threshold value (which may be different to the first threshold value), the signal adjustment module 102-1 adjusts the feedback signal S_{FB} so that the switching signal generation module 102-4 generates a modified switching control signal S′_{SW} which causes the switching element 101-2 to switch with a lower duty cycle, before the decrease in the load current Iₒᵤₜ occurs. The threshold values for triggering the generation of the modified switching control signal S′_{SW} can be determined through calibration. For example, appropriate first and second threshold values may be selected based on measurements of output voltage transients generated by different load changes (e.g. load steps). Suitable threshold values can then be set for the SMPS 100 to trigger the switching of the SMPS 100 using modified switching control signals S′_{SW}, such that output voltage transients are always kept to an acceptable level.

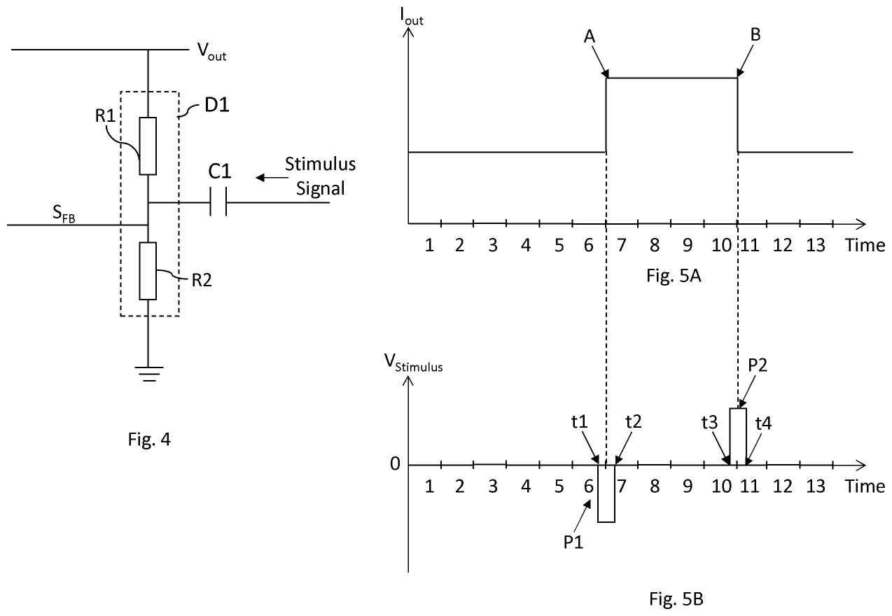

FIG. 4 illustrates a circuit arrangement by which, in response to determining a load current change based on the load scheduling information I_{LS}, the signal adjustment module 102-1 adjusts the feedback signal S_{FB} (obtained via output voltage divider D1 shown in FIG. 4, comprising resistors R1 and R2) by adding a voltage pulse to the feedback signal S_{FB} via a coupling capacitor C1. The capacitor C1 provides a particularly simple way of coupling the voltage pulse (or other stimulus signal generated by the signal adjustment module 102-1) to the feedback signal S_{FB}. In this example, the relationship between the capacitance of the capacitor C1 and the frequency content of the stimulus signal is such that the capacitor C1 transmits the voltage pulse onto the feedback signal with its waveform largely unaltered. In other words, the first-order high-pass filter that is provided by the capacitor C1 and the resistor connecting it to ground (shown in FIG. 4) may have a low enough cut-off frequency to allow the voltage pulse to pass through with its waveform substantially unchanged.

FIG. 5A illustrates an example of a scheduled variation of the load current over a several predetermined time intervals, comprising a step increase A from an initial load current value to an increased load current value at the end of time interval 6, and a subsequent step decrease B from the increased load current value to the initial load current value at the end of time interval 10, while FIG. 5B illustrates a timing diagram (with the same time axis as FIG. 5A) showing the timing and magnitude of example stimulus signals added by the signal adjustment module 102-1 to the feedback signal S_{FB} prior to the respective scheduled load current steps illustrated in FIG. 5A.

The load scheduling information I_{LS} obtained by the controller 102 of the present example comprises a series of data pairs, each data pair comprising a first value indicative of the magnitude of a load current Iₒᵤₜ scheduled to be drawn from the SMPS 100 by the load 120 but which has not yet been drawn, and a second value indicative of the time interval in which the scheduled load current Iₒᵤₜ indicated by the first value is to be drawn from by the load 120. The signal adjustment module 102-1 may, for example, determine the change in the load current Iₒᵤₜ using a value from the load scheduling information I_{LS} that is indicative of a load current Iₒᵤₜ being drawn from the SMPS 100 by the load 120 in a current time interval, and a value from the load scheduling information I_{LS} that is indicative of the load current Iₒᵤₜ that is scheduled to be drawn by the load 120 in the next (future) time interval.

In the present example, the load scheduling information I_{LS} indicates the rising load step A occurring at the end of time interval 6. During time interval 6, the signal adjustment module 102-1 uses the load scheduling information I_{LS} to determine that load step A will occur, by comparing a value indicative of the load current Iₒᵤₜ currently being drawn by the load 120 (i.e. during time interval 6), and a data pair comprised in the load scheduling information I_{LS} which indicates the magnitude of the load current Iₒᵤₜ in the forthcoming time interval 7.

The signal adjustment module 102-1 may, as in the present example, further compare the magnitude of the determined load step A with the first threshold value, as mentioned above. In the present example, the signal adjustment module 102-1 determines that the scheduled increase in the load current Iₒᵤₜ at the end of time interval 6 exceeds the first threshold value, and consequently adds a negative voltage pulse, P1, to the feedback signal S_{FB} at time instance t1 in time interval 6, before the scheduled load increase occurs at the end of time interval 6. The negative voltage pulse P1 causes an increase in the error signal S_{Err}, for the duration of the voltage pulse P1, causing the switching generation module 102-4 to output a modified switching control signal S′_{SW} which has a higher switching duty cycle than before the pulse P1 was added to S_{FB}. Therefore, the controller 102 begins controlling the switching of the switching element 101-2 using the modified switching control signal S′_{SW} at time t1, before the change in the load current Iₒᵤₜ occurs. As a result, the SMPS 100 increases the current Iₒᵤₜ supplied to the load 120 before the scheduled load step occurs at the end of time interval 6. When the voltage pulse P1 ends at time t2 during time interval 7, the controller 102 resumes normal switching operation using the switching control signal S_{SW}. In this manner, the SMPS 100 is able to increase its output current Iₒᵤₜ in anticipation of the forthcoming load step to suppress a voltage transient which would arise as a consequence of the load step.

In the present example, the controller 102 further obtains, from the load scheduling information I_{LS}, an indication of a scheduled decrease in the load current Iₒᵤₜ occurring at the end of time interval 10. The signal adjustment module 102-1 may, as in the present example, further compare the magnitude of the scheduled decrease with the second threshold value, as noted above. In the present example, the signal adjustment module 102-1 determines that the scheduled decrease in the load current Iₒᵤₜ at the end of time interval 10 exceeds the second threshold value, and consequently adds a positive voltage pulse, P2, to the feedback signal S_{FB} at time instance t3 in time interval 10, before the scheduled load decrease occurs at the end of time interval 10. The controller 102 accordingly generates a modified switching control signal S′_{SW} at time t3 during time interval 10 to cause the SMPS 100 to temporarily operate with a lower switching duty cycle. This is achieved by the signal adjustment module 102-1 adding the positive voltage pulse P2 onto the feedback signal S_{FB} at time t3, just before the load current decrease occurs at the end of time interval 10. The positive voltage pulse P2 decreases the error signal V_{Err} for the duration of the voltage pulse P2, causing the switching signal generation module 102-4 to output a modified switching control signal S′_{SW} having a lower switching duty cycle than prior to the pulse P2 being added to the feedback signal S_{FB}. As a result, the SMPS 100 decreases the current Iₒᵤₜ supplied to the load 120, before the scheduled load current decrease occurs.

When the signal adjustment module 102-1 determines a scheduled change in load current Iₒᵤₜ that exceeds the predetermined threshold, the signal adjustment module 102-1 may cause the switching signal generation module 102-4 to immediately generate and add the modified switching control signal S′_{SW} to the feedback signal S_{FB}. However, it may be preferable for the signal adjustment module 102-1 to delay causing the switching signal generation module 102-4 to generate the modified switching control signal S′_{SW} for a period of time, in order to more effectively suppress the voltage transient caused by the load change. Optimum start timing for generating the modified switching control signal S′_{SW} may be determined by trial and error, for example. The modified switching control signal S′_{SW} should not be generated too early before the load change occurs, as this may cause a large initial deviation in the SMPS output voltage Vₒᵤₜ. However, the modified switching control signal S′_{SW} should be generated sufficiently early to account for propagation delay of the SMPS 100, so that the required extra power is delivered to the load 120 when the load change occurs.

The signal adjustment module 102-1 may be configured to determine parameters of each voltage pulse based on the change in the load current Iₒᵤₜ determined on the basis of the load scheduling information I_{LS}. These parameters may include the polarity of the voltage pulse to be generated, its amplitude and/or duration. The signal adjustment module 102-1 may classify a determined load current change as belonging to a respective one of a plurality of predetermined load current change categories stored in the memory 203 of the controller 102. The signal adjustment module 102-1 may then generate a voltage pulse signal based on voltage pulse generation parameters stored in association with the corresponding load current change category.

In the present embodiment, the signal adjustment module 102-1 is configured to determine the amplitude of the voltage pulse signal to be generated based on the indication of the load current change provided by the load scheduling information I_{LS}, such that the amplitude of the voltage pulse signal increases with the size of the load step, as a larger load step may require a larger pre-adjustment of the feedback signal S_{FB} in order to change the output current Iₒᵤₜ to a level that is sufficient to suppress the output voltage transient.

The signal adjustment module 102-1 may additionally or alternatively be configured to determine the duration of the voltage pulse to be generated based on the indication of the load current change determined by the signal adjustment module 102-1 on the basis of the load scheduling information I_{LS}, such that the duration of the voltage pulse increases with the amplitude of a forthcoming load step. Increasing the duration of the voltage pulse results in a longer change in the level of current supplied by the SMPS 100, allowing the SMPS 100 to pre-supply the required level of load current Iₒᵤₜ before the load step occurs.

The transient response of the SMPS 100 may be measured for each of a plurality of different forms of the stimulus signal that has been generated by the signal adjustment module 102-1 (e.g. each form of stimulus signal having a different respective voltage amplitude and/or duration) in response to each of a plurality of different load current changes, and the measurement results used to build up a response map (e.g. in the form of a look-up table), which associates each load current change with a respective stimulus signal (as defined by an amplitude and a duration of a voltage pulse, for example) that has been found to be effective in suppressing the voltage transient caused by the load current change. The signal adjustment module 102-1 may use such a response map to determine (e.g. by look-up or by interpolation between values in the response map) an appropriate stimulus signal for suppressing a voltage transient to be caused by a scheduled load current change that is indicated by the load scheduling information.

In an alternative embodiment, where the indication of the change in the load current provided by the load scheduling information I_{LS} comprises changes in the load current that is to be drawn by the load from the SMPS (e.g. a plurality of step changes, or a continuous variation of the load current Iₒᵤₜ), the signal adjustment module 102-1 may be configured to generate, as the stimulus signal, a stimulus voltage whose amplitude varies over time, the variation of the amplitude of the stimulus voltage over time being determined using the indication of the scheduled changes in the load current provided by the load scheduling information I_{LS} such that the addition of the stimulus voltage to the one or more of the reference signal, the feedback signal, error signal and the duty cycle control signal causes the switching signal generation module 102-4 to generate the modified switching control signal S′_{SW} to control the switching of the switching element 101-2 before the changes in the load current Iₒᵤₜ occur, in order to suppress voltage transients in the output voltage Vₒᵤₜ caused by the changes in the load current.

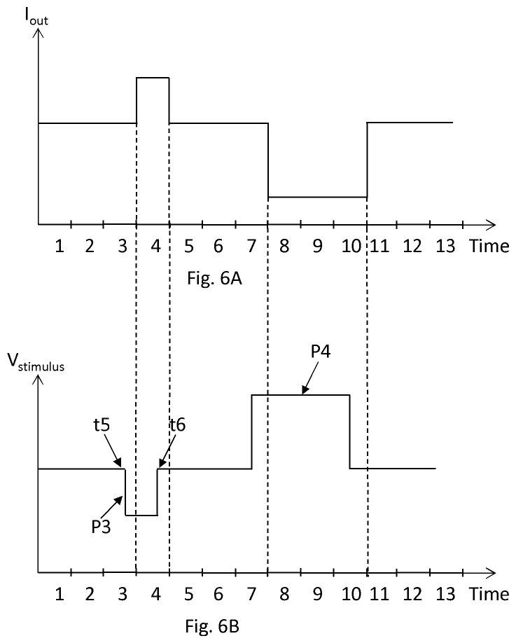

For example, the signal adjustment module 102-1 may be configured to add to the feedback signal S_{FB}, instead of a voltage pulse, a stimulus signal in the alternative form of a scaled image of the scheduled load current variation over time to the feedback signal S_{FB} via the coupling capacitor C1, such that the variation of the stimulus signal over time is a scaled version of the variation of the load current over time (obtained by multiplying each value defining the load current variation by a scaling factor). In this alternative embodiment, the relationship between the capacitance of the coupling capacitor C1 and the frequency content of the stimulus signal may be such that the signal output by the coupling capacitor C1 (which is added to the feedback signal S_{FB}) is approximately a derivative of the stimulus signal generated by the signal adjustment module 102-1 and input to the coupling capacitor C1. In other words, the first-order high-pass filter that is provided by the capacitor C1 and the resistor connecting it to ground (shown in FIG. 4) may have a cut-off frequency that allows it to effectively output a derivative of the input stimulus signal. Thus, in a case where the stimulus signal comprises a step change in the voltage, the step change in the voltage may emerge from the coupling capacitor C1 as a voltage spike. Thus, for example, a rising edge of a voltage pulse input to the coupling capacitor C1 would result in the addition of a positive voltage spike to the feedback signal S_{FB}, while the falling edge of a voltage pulse input to the coupling capacitor C1 would result in the addition of a negative voltage spike to the feedback signal S_{FB}. This alternative embodiment will now be described in more detail with reference to FIGS. 6A and 6B.

In FIG. 6A, during time interval 3, the signal adjustment module 102-1 receives load scheduling information I_{LS} comprising a first pair of values indicative of the scheduled load current Iₒᵤₜ that is to be drawn by the load 120 during time interval 4, and a second pair of values indicative of the scheduled load current Iₒᵤₜ that is to be drawn by the load 120 during time interval 5. The signal adjustment module 102-1 may use the received load scheduling information, and a received value that is indicative of the load current Iₒᵤₜ drawn by the load 120 during the present time interval (time interval 3), to determine that a rising load step will occur at the end of time interval 3. The signal adjustment module 102-1 thus generates a (negative) voltage pulse P3, as illustrated in FIG. 6B, and inputs the generated voltage pulse P3 to the coupling capacitor C1 at a time t5, before the occurrence of the load step at the end of time interval 3. In this embodiment, the magnitude of the voltage pulse P3 is determined by the signal adjustment module 102-1, based on the magnitude of the load step, and the duration of the voltage pulse P3 is determined by the signal adjustment module 102-1 based the duration of the corresponding first load change shown in FIG. 6A. In the present example, the duration of the voltage pulse P3 is substantially the same as the duration of the corresponding load change. At time t5, the voltage drop at the leading edge of the voltage pulse P3 causes a voltage spike to be output by the capacitor C1, resulting in a corresponding spike in the feedback voltage S_{FB} and causing the switching signal generation module 102-4 to generate a modified switching control signal S′_{SW} of a higher duty cycle, thus increasing the output current Iₒᵤₜ. Accordingly, when the load current Iₒᵤₜ increase occurs at the end of time interval 3, the SMPS 100 has enough energy to meet the new load demand, and a voltage sag of the SMPS output voltage can thus be suppressed.

Furthermore, at time t6, the rising edge of the negative voltage pulse P3 injected into the coupling capacitor C1 results in a positive voltage spike being coupled to the feedback signal S_{FB}, causing a temporary increase in the feedback signal S_{FB} and consequently the SMPS 100 to switch with a reduced duty cycle, effectively reducing the output current Iₒᵤₜ. Accordingly, when the load current decrease occurs at the end of time interval 4, the SMPS 100 has already brought its energy level in line with the new load current level. In this manner, a transient in the output voltage Vₒᵤₜ of the SMPS 100 can be suppressed or prevented.

The magnitude and the duration of the voltage pulse generated by the signal adjustment module 102-1 may be determined by the signal adjustment module 102-1 so as to increase with the magnitude and the duration of the corresponding load change, respectively. This is illustrated in FIGS. 6A and 6B, where the signal adjustment module 102-1 generates and injects a stimulus signal P4 with a longer duration and larger magnitude in response to the larger and longer load step occurring during time intervals 8, 9 and 10.

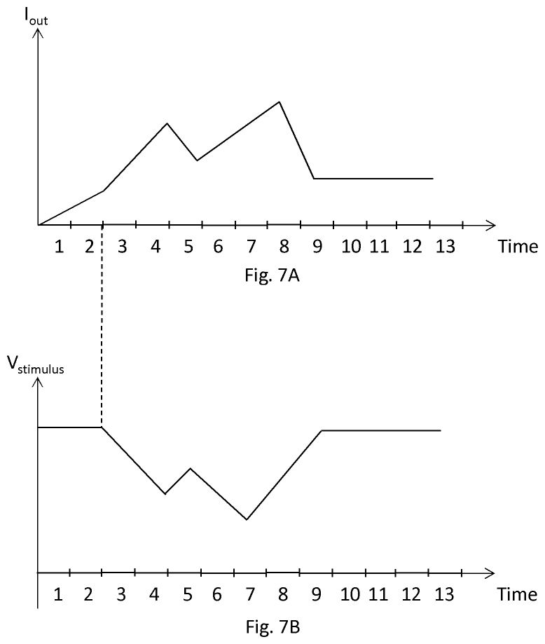

It should be noted that the scheduled load current variation over time indicated by the load scheduling information need not comprise only step changes in the load current, but may additionally or alternatively comprise one or more time intervals during which the load current is scheduled to ramp up or down, for example as illustrated in FIGS. 7A and 7B. The signal adjustment module 102-1 may thus track the scheduled variation in the load current Iₒᵤₜ over time and generate, and inject a stimulus signal with a magnitude that varies in a corresponding manner. By using a stimulus signal with the magnitude envelope that is a scaled version of the envelope of the scheduled load current variation, the SMPS 100 can accurately pre-adjust its supplied power for all load current Iₒᵤₜ changes that may affect SMPS 100 output voltage stability. More effective removal of voltage transients can therefore be realized.

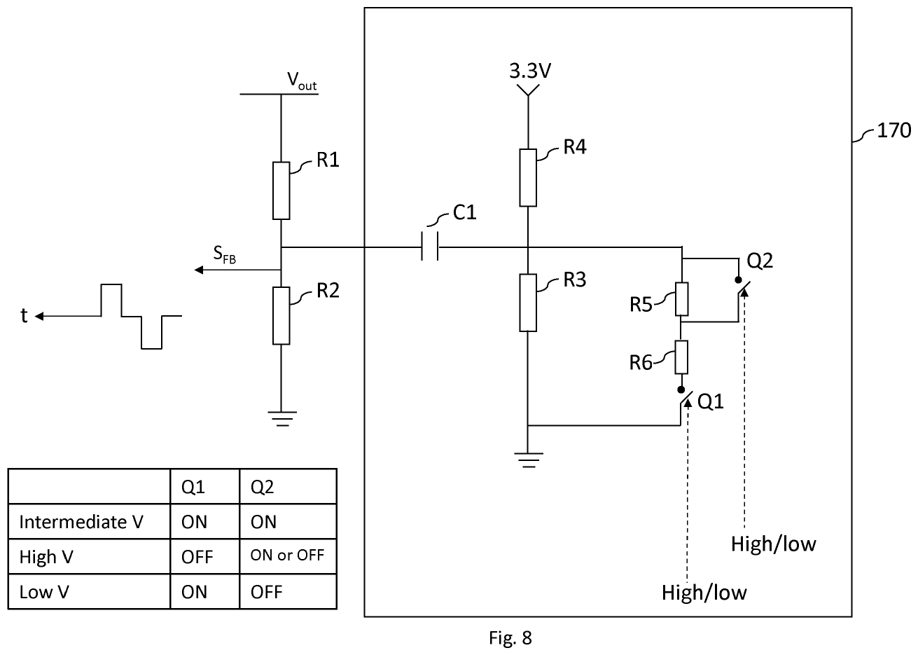

FIG. 8 illustrates an example implementation of the signal adjustment module 102-1 and, in particular, a circuit thereof that allows positive and negative voltage pulses to be added to the feedback signal S_{FB}. In this example, the signal adjustment module 170 comprises a circuit having resistors R3 to R6, capacitor C1 and switching elements (e.g. transistors) Q1 and Q2, arranged in the manner illustrated in FIG. 8. In the present example, the feedback signal S_{FB} is taken from the output voltage Vₒᵤₜ of the SMPS 100 via a feedback voltage divider comprising resistors R1 and R2. The signal adjustment module 170 adjusts the feedback signal S_{FB} by controlling switches Q1 and Q2 to add a voltage pulse to the feedback signal S_{FB}, via the coupling capacitor C1. Resistors R3 to R6 and switching elements Q1 and Q2 allow either a positive or a negative voltage pulse to be generated and coupled to the feedback signal S_{FB}. Each of the switching elements Q1 and Q2 is controlled by a HIGH or LOW switching signal generated by the signal adjustment module 170. The signal adjustment module 170 further controls the duration of the HIGH or LOW switching signals in order to vary the duration of the generated voltage pulses.

In the present example, when no voltage pulse needs to be added to the feedback signal S_{FB}, both switching elements Q1 and Q2 are kept in an ON state. Due to the presence of capacitor C1, a voltage pulse is added to the feedback signal S_{FB} only when the switch configuration is changed. In the present example, when the signal adjustment module 170 is required to add a positive voltage pulse to the feedback signal S_{FB}, the signal adjustment module 170 turns switching element Q1 OFF for a short duration and then switches it back to its default ON state. This causes a positive voltage pulse to be added to the feedback signal S_{FB}. On the other hand, when the signal adjustment module 170 needs to add a negative pulse to the feedback signal S_{FB}, switching element Q2 is turned OFF for a brief period from its default ON state, before being turned back ON. This causes a negative voltage pulse to be added to the feedback signal S_{FB}.

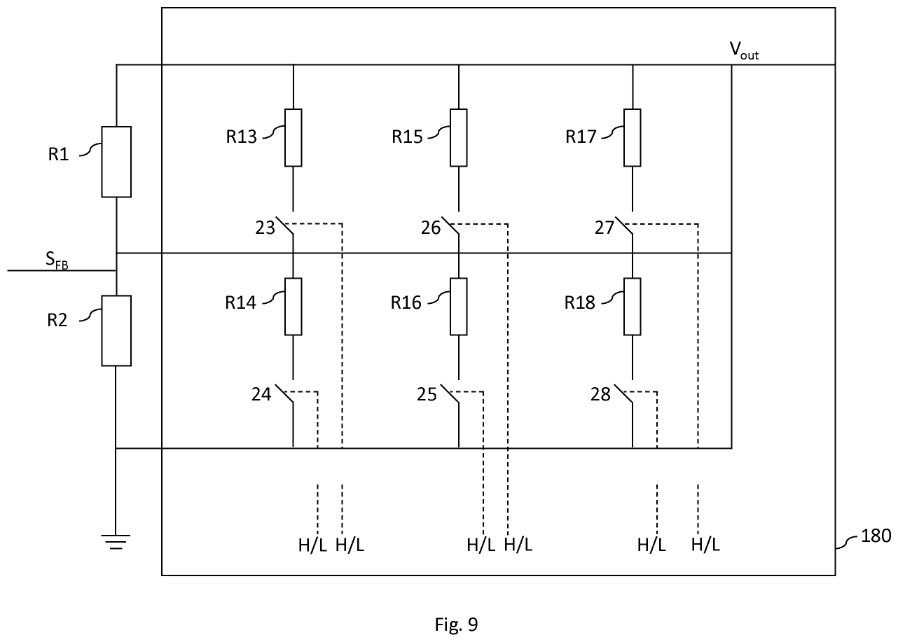

FIG. 9 illustrates another example implementation of the signal adjustment module 102-1 and, in particular, a circuit thereof that allows positive and negative voltage pulses to be added to the feedback signal S_{FB}. In the present example, the signal adjustment module 180 comprises a circuit having resistors R13 to R18 and switching elements (e.g. transistors) Q3 to Q8. Each of the switching elements Q3 to Q8 is controlled by a respective HIGH or LOW switching signal generated by the signal adjustment module 180, such that the voltage level of the feedback signal S_{FB} can be offset by one of a number of pre-set amounts. The signal adjustment module 180 further controls the duration of the HIGH or LOW switching signal, in order to vary the duration of the stimulus pulse and therefore the duration of the adjustment to the feedback signal S_{FB}. The signal adjustment module 180 may further be pre-configured with instructions on which of the switching elements Q3 to Q8 should be switched ON, and how long for, for each of a plurality of determined load current changes. Compared with the embodiment in FIG. 8, the present embodiment does not require the use of a coupling capacitor C1 at the feedback signal input point of the controller 102.

In the present embodiment, when no adjustment of the feedback signal S_{FB} is to be performed, switching elements Q3 to Q8 are all controlled to be in an OFF state. When the signal adjustment module 180 is required to decrease the feedback voltage S_{FB} for a period of time, the signal adjustment module 180 decreases the feedback voltage S_{FB} by turning switching element Q4 from the OFF state to the ON state. The signal adjustment module 180 may cause a larger decrease in the feedback voltage S_{FB} (for example, in response to a larger rising load step) by switching both switching elements Q4 and Q5 to the ON state. Accordingly, by using different switching combinations and by, a plurality of feedback signal level shifts can be obtained. To determine the required switching signal for switching elements Q3 to Q8, a reference table mapping different load step sizes to digital input control signals of the signal adjustment module 180 can be used. For example, the lookup table may indicate, for a scheduled load step, which of the switching elements Q3 to Q8 should be switched, and the duration for which each switching element should be switched.

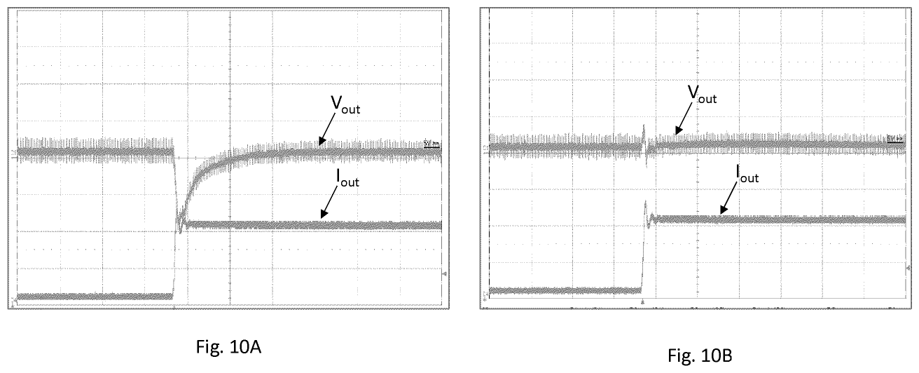

FIG. 10A shows the result from measurement on a lab coupling of a conventional SMPS to a step change in the load current drawn from the SMPS by a load. A large dip in the output voltage of the SMPS is observed to occur in response to the change in the load current.

FIG. 10B shows the result from measurement on a lab coupling of an SMPS according to an embodiment to a step change in the load current drawn from the SMPS by a load. In this example, the SMPS is assumed to generate a modified switching signal S′_{SW} by adjusting the feedback signal S_{FB} using a pulse coupling scheme as described above with reference to FIG. 6B and FIG. 8. As shown in FIG. 10B, the large output voltage dip evident in FIG. 10A is almost completely suppressed.

Many modifications and variations can be made to the embodiment and its variants described above. For example, in the first embodiment, although the feedback signal S_{FB} is adjusted by the signal adjustment module 102-1, a similar approach may be taken to instead adjust the error signal S_{Err}, the duty cycle control signal S_{duty}, or the reference voltage V_{Ref}, in order to control the switching element 101-2 using a modified switching control signal S′_{SW}.

Moreover, although the examples in FIGS. 5 and 6 use load scheduling information I_{LS} comprising a series of data pairs each providing time and load information, the load scheduling information I_{LS} may alternatively take another forms. For example, the load scheduling information I_{LS} provided to the controller 102 may comprise data indicating the scheduled change in the magnitude of the load current Iₒᵤₜ. This load scheduling information I_{LS} may be provided to controller 102 periodically, or it may be alternatively provided aperiodically, for example, only when a determined load step exceeding a predetermined threshold is detected. In embodiments where each load scheduling information I_{LS} indicates a single scheduled change in the load current Iₒᵤₜ, timing information for the scheduled change may not need to be indicated in the load scheduling information, as controller 102 can process the load scheduling information I_{LS} as soon as it receives it. However, when the load scheduling information I_{LS} indicates a sequence of scheduled load current changes, timing information for each scheduled load current change may need to be indicated in the load scheduling information I_{LS}.

Furthermore, the nature of the stimulus signal generated by the signal adjustment module 102-1 will depend on which of these signals is to be adjusted, as will be appreciated by those skilled in the art. For example, for the particular controller 102 implementation described with reference to FIGS. 3, 4, 5A and 5B, the signal adjustment module 102-1 injects (via capacitor C1) a negative voltage pulse into the feedback point between resistors R1 and R2 in response to obtaining an indication of a scheduled load increase. However if the voltage pulse is to be injected onto the reference voltage V_{Ref} instead, the controller 102 will instead inject a positive voltage pulse in response to determining a scheduled load increase, in order to cause the switching element 101-2 to switch with a higher duty cycle. The characteristics of the stimulus signal generated by the signal adjustment module also depend on design choices.

### Embodiment 2

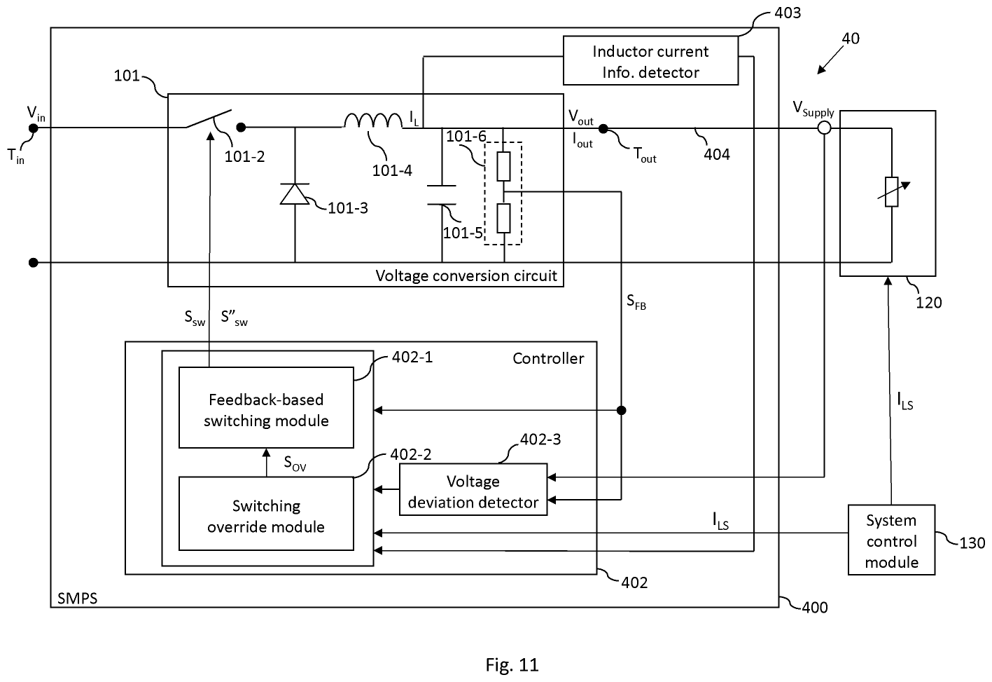

FIG. 11 illustrates a system 40 comprising an SMPS 400 according to a second embodiment, which is operable to supply power to a load 120 also forming part of the system 40. The SMPS 400 comprises a voltage conversion circuit 101, which is the same as in the first embodiment, a controller 402 and (optionally) an inductor current information detector 403. The system 40 further comprises a system control module 130, which provides the load scheduling information, I_{LS}, to the SMPS 400 and is the same as that referred to in the above description of the first embodiment. It should be noted that the system control module 130 need not be a stand-alone device, and could alternatively form part of the SMPS 400 or the load 120, for example. For instance, when the system 40 is part of a telecommunication system, the system control module 130 may form part of the radio unit or part of the baseband unit, depending on the radio access network architecture.

In the first embodiment and the variants thereof described above, the controller 102 is configured to suppress voltage transients in the output voltage Vₒᵤₜ of the SMPS 100 using a modified switching control signal S′_{SW}, which is a modified form of the pulse width modulation signal used in normal output voltage regulation and is generated by adjusting the feedback control loop that is employed by the SMPS 100 to regulate its output voltage Vₒᵤₜ, the adjustment being based on an indication of a change in the load current Iₒᵤₜ that is provided by the load scheduling information I_{LS}. The controller 402 of the present embodiment, on the other hand, is configured to generate a modified switching control signal in the alternative form of a modified switching control signal S″_{SW}, which overrides the switching control signal S_{SW} employed during normal output voltage regulation and causes the voltage conversion circuit 101 to sink current at its output to a current sink (e.g. ground), or to source current from the input terminal Tᵢₙ of the SMPS 400 to its output terminal Tₒᵤₜ, for a period of time determined on the basis of the load scheduling information I_{LS}, so as to suppress a voltage transient in the output voltage Vₒᵤₜ caused by scheduled load current changes. As with first embodiment and the variants thereof described above, the present embodiment makes use of advance knowledge of load information to adjust the operation of the SMPS 400 before a scheduled load change occurs, in order to suppress a transient in the output voltage Vₒᵤₜ of the SMPS 400 which would result from the load change.

More particularly, the controller 402 of the present embodiment is configured to generate, in a case where the indication of the change in the load current Iₒᵤₜ provided by the load scheduling information I_{LS} indicates a scheduled decrease in the load current Iₒᵤₜ, as a modified switching control signal S″_{SW}, a first control signal which causes the voltage conversion circuit 101 to provide a DC path (i.e. an electrical connection that allows a DC current to flow) between the output terminal Tₒᵤₜ of the SMPS 400 and a current sink (e.g. earth/ground) before the scheduled decrease in the load current Iₒᵤₜ occurs, and for a first period of time that is based on the indication of the scheduled decrease in the load current Iₒᵤₜ, so as to suppress a voltage transient in the output voltage Vₒᵤₜ caused by the decrease in the load current Iₒᵤₜ. By way of an example, the controller 402 of the present embodiment is configured to generate, as the first control signal, a control signal which opens (turns to the OFF state) switching element 101-2, so as to provide a DC path between the output terminal Tₒᵤₜ of the SMPS 400 and earth (ground) via the diode 101-3, before the scheduled decrease in the load current Iₒᵤₜ occurs and for the aforementioned first period of time.

Furthermore, in a case where the indication of the change in the load current Iₒᵤₜ provided by the load scheduling information I_{LS} indicates a scheduled increase in the load current Iₒᵤₜ, the controller 402 is configured to generate, as the modified switching control signal S″_{SW}, a second control signal which causes the voltage conversion circuit 101 to provide a DC path between the input terminal Tᵢₙ and the output terminal Tₒᵤₜ of the SMPS 400 before the scheduled increase in the load current Iₒᵤₜ occurs and for a second period of time that is based on the indication of the scheduled increase in the load current Iₒᵤₜ, so as to suppress a voltage transient in the output voltage Vₒᵤₜ caused by the increase in the load current Iₒᵤₜ. By way of an example, the controller 402 of the present embodiment is configured to generate, as the second control signal, a control signal which closes switching element 101-2 so as to provide a DC path between the input terminal Tᵢₙ and the output terminal Tₒᵤₜ of the SMPS 400 before the scheduled increase in the load current Iₒᵤₜ occurs, and for the aforementioned second period of time.

The SMPS 400 of the present embodiment is thus configured to be able to switch between operating in a first mode of operation and a second mode of operation. In the first mode of operation, the controller 402 generates the switching control signal S_{SW} based on the feedback signal S_{FB} and regulates the output voltage Vₒᵤₜ of the SMPS 400 by controlling the switching element 101-2 in the voltage conversion circuit 101 using the switching control signal S_{SW}. In the present embodiment, the switching control signal S_{SW} employed in the first mode of operation is generated by a feedback-based switching module 402-1 shown in FIG. 11, which comprises an arrangement of the error signal generation module 102-2, the feedback compensation module 102-3 and the switching signal generation module 102-4 described above in connection with the first embodiments and the variants thereof.

In the second mode of operation, the controller 402 controls the switching element 101-2 of the voltage conversion circuit 101 using the modified switching control signal S″_{SW} to interrupt the first mode of operation and cause the voltage conversion circuit 101 to either source current to the power supply line 404 connecting the SMPS 400 to the load 120 (by causing the voltage conversion circuit 101 to provide a DC path between the input Tᵢₙ and output Tₒᵤₜ of the SMPS 400) or sink current from the power supply line 404 to the ground (by causing the SMPS 400 to provide a DC path between the output Tₒᵤₜ and the current sink) for a period of time that is determined based on the indication of load current change obtained using the load scheduling information I_{LS}. This sourcing or sinking operation is performed before the scheduled load change occurs.

In the example illustrated in FIG. 11, the controller 402 further comprises a switching override module 402-2, which uses the load scheduling information I_{LS} to determine a scheduled change in the load current Iₒᵤₜ. The switching override module 402-2 is further configured to provide a switching override signal, S_{OV}, to the feedback-based switching control module 402-1 to cause the feedback-based switching module 402-1 to stop controlling the switching of the switching element 101-2 using the switching control signal S_{SW}, and to instead control the switching of the switching element 101-2 to using the modified switching control signal S″_{SW}, as described above.

In the present embodiment, when the switching override module 402-2 is configured to compare the determined load current change with a predetermined threshold, and to provide the switching override signal S_{OV} to the feedback-based switching module 402-1 only when the determined load current change exceeds the predetermined threshold. Thus, in a case the determined load current change does not exceed the predetermined threshold, the feedback-based switching module 402-1 operates in the first mode to regulate the output voltage Vₒᵤₜ using the feedback signal S_{Fb}.

More particularly, when the switching override module 402-2 determines there to be a scheduled change in the load current Iₒᵤₜ that is smaller than a (negative valued) first predetermined threshold, ΔI_{T1}, the switching override module 402-2 interrupts operation of the feedback-based switching module 402-1 in the first mode by sending a switching override signal S_{OV} to the feedback-based switching module 402-1, causing the feedback-based switching module 402-1 to instead operate in the second mode by switching the switching element 101-2 to the OFF state (i.e. opening the switching element 101-2) for a period of time before the scheduled load decrease occurs. The period of time for which the switching element 101-2 is kept in the OFF state is determined by the switching override module 402-2 based on the magnitude of the scheduled load current decrease. In this manner, the controller 402 switches the switching element 101-2 with a modified switching control signal S″_{SW} to cause the voltage conversion circuit 101 to provide a DC path between the output Tₒᵤₜ of the SMPS 400 and ground, thereby sinking current from the load 120. Accordingly, the voltage conversion circuit 101 is able to decrease the level of current supplied to the load 120 before the scheduled load current decrease occurs, therefore suppressing a voltage spike which would result from the load current decrease.

When the switching override module 402-2 determines there to be a scheduled change in the load current Iₒᵤₜ that is greater than a (positive valued) second predetermined threshold, ΔI_{T2}, the switching override module 402-2 interrupts operation of the feedback-based switching module 402-1 in the first mode by sending a switching override signal S_{OV} to the feedback-based switching module 402-1, causing the feedback-based switching module 402-1 to instead operate in the second mode by switching the switching element 101-2 to the ON state (i.e. closing the switching element 101-2) for a period of time before the scheduled load increase occurs. The duration for which the switching element 101-2 is kept in the ON state is determined by the switching override module 402-2 based on the magnitude of the scheduled load current increase. In this manner, the controller 402 switches the switching element 101-2 with a modified switching control signal S″_{SW} to cause the voltage conversion circuit 101 to provide a DC path between the input Tₒᵤₜ and the output Tₒᵤₜ of the SMPS 400, thereby sourcing current to the load 120. This allows the voltage conversion circuit 101 to increase the level of current supplied before the scheduled load current increase occurs, therefore suppressing a voltage sag which would result from the load current increase.

It is noted that the load scheduling information I_{LS} used by the controller 402 in the present embodiment may take the same form as described for previous embodiments. Furthermore, the controller 402 may be configured to determine the indication of change in the load current Iₒᵤₜ based on the load scheduling information I_{LS} in the same manner as already described in the previous embodiments, and therefore, these details will not be repeated here.

In the present embodiment, the modified switching control signal S″_{SW} is generated by the feedback-based switching module 402-1 when it receives a switching override signal S_{OV} from the switching override module 402-2. However, in alternative embodiments, the switching override module 402-2 may generate the modified switching control signal S″_{SW} itself, instead of controlling the feedback-based switching module 402-1 to do so.

Alternatively, in some embodiments, the controller 402 may comprise a gate control module for controlling the switching element 101-2, which may be configured to receive the switching control signal S′_{SW} from the feedback-based switching module 402-1 and the modified switching control signal S″_{SW} from the switching override module 402-2, and to apply the switching control signal _{S′SW} to the switching element 101-2 only when no modified switching control signal S″_{SW} is received from the signal override module 402-2, and to apply the modified switching control signal S″_{SW} to the switching element 101-2 when the modified switching control signal S″_{SW} is received from the signal override module 402-2. In other words, the gate control module may convey the switching control signal S′_{SW} from the feedback-based switching module 402-1 to the switching element 101-2 such that the controller 402 operates in the first mode, interrupting the operation in the first mode only when the gate control module receives the modified switching control signal S″_{SW} from the signal override module 402-2, in which case the gate control module conveys the modified switching control signal S″_{SW} from the signal override module 402-2 to the switching element 101-2 such that the controller 402 operates in the second mode.

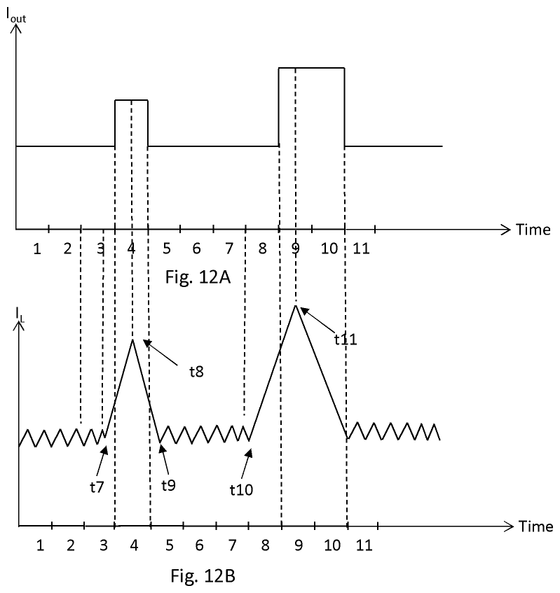

FIG. 12A is a timing diagram illustrating step changes in the load current Iₒᵤₜ drawn from the SMPS 400 by the load 120, which are scheduled to occur over a respective time intervals. FIG. 12B illustrates, on the same time scale as FIG. 12A, a variation of the inductor current I_{L} which occurs as a result of the controller 402 controlling the switching element 101-2 using the modified switching control signal S″_{SW} to source and sink current based on advance knowledge of the load steps illustrated in FIG. 12A.

The controller 402 receives, at the start of time interval 3, load scheduling information I_{LS} comprising an indication of load current Iₒᵤₜ scheduled to be drawn by the load in time interval 4. The controller 402 uses the received load scheduling information I_{LS} to determine that a rising load step will occur at the start of time interval 4, by comparing a value indicative of the load current Iₒᵤₜ for time interval 3 (which may, as in the present example, be obtained using a previously obtained item of load scheduling information I_{LS}) with a value indicative of the scheduled load current Iₒᵤₜ for time interval 4. The controller 402 further determines that the scheduled rising load step has a magnitude that exceeds the (positive valued) first predetermined threshold ΔI_{T1}. Therefore, at time t7, before the load step occurs, the controller 402 controls the voltage conversion circuit 101 with a modified switching control S″_{SW} to close the switching element 101-2 so as to provide a DC path from Tᵢₙ to Tₒᵤₜ and thus source current to the load 120, for a period of time determined based on the size of the rising load step. In FIG. 12A, the sourcing operation is illustrated by the rapid increase in the level of current flowing through the inductor element 101-4, which starts at time t7. In the present example, the current sourcing is performed for a period sufficiently short period such that the increase in the output voltage Vₒᵤₜ as a result of the current sourcing operation is small. The rate at which the inductor current I_{L} increases during the current sourcing operation can therefore be approximated by

$$\frac{V i n - Vout}{L} ,$$

where L is the inductance of the inductor element 101-4.

At the start of time interval 4, the controller 402 obtains further load scheduling information I_{LS}, and determines an indication of load current Iₒᵤₜ scheduled to be drawn by the load 120 during time interval 5. From this load scheduling information I_{LS}, the controller 402 determines that a falling load step will occur at the start of time interval 5, by comparing the value indicative of the load current Iₒᵤₜ for time interval 4 with the value indicative of the scheduled load current Iₒᵤₜ for time interval 5. The controller 402 further determines that the scheduled load step has a magnitude that is smaller than the (negative valued) second predetermined threshold, ΔI_{T2}. Therefore, at time t8, before the falling load step occurs at the start of time interval 5, the controller 402 controls the voltage conversion circuit 101 with a modified switching control signal S″_{SW} to open the switching element 101-2 so as to provide a DC path from Tₒᵤₜ to ground and thus sink current from the load 120 to the ground for a period of time determined based on the size of the falling load step. In FIG. 12B, the sinking operation is illustrated by the rapid decrease in the level of current flowing through the inductor element 101-4, which starts at time t8. In the present example, it is assumed that the current sinking operation is performed for a period sufficiently short such that the deviation in the output voltage Vₒᵤₜ due to the current sinking operation is negligible. The rate at which the inductor current I_{L} decreases during the current sinking operation can therefore be approximated by

$$\frac{Vout}{L} .$$

In the present embodiment, the controller 402 is further configured to determine the time duration for controlling the switching element 101-2 using the modified switching control signal S″_{SW} (namely, the duration of the current sourcing or current sinking operation), and the timing for commencing the controlling of the switching element 101-2 using the modified switching control signal S″_{SW} (i.e. the start time for performing sourcing or sinking of current), based on the magnitude of scheduled load step that has been determined using the load scheduling information I_{LS}. In particular, for a given rate of change of the inductor current with time, it may not be appropriate for the controller 402 to apply the modified switching control signal S″_{SW} immediately upon determining the scheduled load step. Instead, the controller 402 of the present embodiment is configured to determine the start timing and the duration of the current sourcing or current sinking operation based on the size of the determined load step. More specifically, under the assumption that the duration of the current sourcing or current sinking operation is negligible, a linear rate of change of the inductor current with time can be assumed when determining the duration and the start timing of the sourcing or sinking operation. In particular, a longer period of sourcing or sinking is performed for a larger scheduled load step, in order to allow the SMPS 400 to change its inductor current level to a level that reduces or prevents a voltage transient when the scheduled load step occurs.

It should be noted that, in the present embodiment, the duration of the sourcing or sinking operation is related to the start timing for performing the current sourcing or current. In particular, in order to suppress a voltage transient caused by a load step, the controller 402 is configured to control the voltage conversion circuit 101 to source or sink current before the load step occurs, such that the level of the inductor current flowing through the inductor element 101-4 substantially reaches the new load current level (i.e. the level of the load step) when the load step actually occurs. Accordingly, the larger the load step determined on the basis of the load scheduling information I_{LS}, the earlier the controller 402 of the present embodiment applies the modified switching control signal S″_{SW} in order to change the inductor current level to the target load current level, effectively performing sourcing or sinking for a longer period. This is illustrated in FIG. 12B, where, upon determining that a larger load step will occur at the start of time interval 9 than at the start of time interval 4, the controller 402 starts to control the switching element 101-2 to start sourcing current from a time instance (t10, within time interval 8) that occurs earlier before the scheduled load change at the start of time interval 9 than the time instance (t7, within time interval 3) that occurs earlier before the scheduled load change at the start of time interval 4 (in other words, the time that elapses between time t10 and the end of time interval 8 is greater than the time that elapses between time t7 and the end of time interval 3), and sources current for a longer duration until time instance t11. Similarly, the controller 402 also controls the voltage conversion module 101 using a modified switching control signal S″_{SW} to sink current for a longer period in response to determining a larger falling load step scheduled to occur at the start of time interval 11.

In some embodiments, the controller 402 is further configured to obtain, after determining the scheduled change in the load current Iₒᵤₜ, inductor current information indicative of a value of the inductor current I_{L} flowing through the inductor element 101-4 of the SMPS 100 before the scheduled change in the load current Iₒᵤₜ occurs. In these embodiments, the controller 402 is further configured to determine the time duration for controlling the switching element 101-2 using the modified switching control signal S″_{SW} (to cause the voltage conversion circuit 101 to source current or sink current) based on the indicated value of the inductor current I_{L} and the load current change determined based the load scheduling information I_{LS}.

In the case where the indication of the change in the load current Iₒᵤₜ indicates a scheduled decrease in the load current Iₒᵤₜ, the controller 402 is configured to determine the duration of the current sinking operation based on the indication of the scheduled decrease in the load current Iₒᵤₜ and inductor current information that is indicative of a value of a inductor current I_{L} before the scheduled decrease in the load current Iₒᵤₜ occurs. In particular, the controller 402 is configured to increase the duration of the current sinking operation with increasing size of the scheduled decrease in the load current Iₒᵤₜ and with increasing value of the current I_{L} flowing through the inductor element 101-4. Starting from a higher inductor current level, the current sinking operation may need to be performed for a longer period of time in order to allow the inductor current I_{L} to decrease to a sufficiently low level such that an output voltage spike can be prevented when the scheduled load current decrease occurs.

Furthermore, in the case where the indication of the change in the load current Iₒᵤₜ indicates a scheduled increase in the load current Iₒᵤₜ, the controller 402 may be configured to determine the duration of the current sourcing operation based on the indication of the scheduled increase in the load current Iₒᵤₜ and the inductor current information that is indicative of the value of the inductor current I_{L} flowing through the inductor element 101-4 before the scheduled increase in the load current Iₒᵤₜ occurs, and to increase the duration of the current sourcing operation with increasing size of the scheduled increase in the load current Iₒᵤₜ and with decreasing value of the current flowing through the inductor element 101-4. The inductor current I_{L} is indicative of the energy level of the SMPS 400 and, as the indicated value of the inductor current I_{L} decreases, then for a scheduled rising load step, the duration of the current sourcing operation may need to increase in order to allow the inductor current I_{L} to rise to a level sufficient to reduce or prevent an output voltage sag when the scheduled load current increase occurs.

In the present embodiment, the controller 402 is configured to receive, as the inductor current information, one or more measured values of the current flowing through the inductor element 101-4. For example, the controller 402 may, as in the present embodiment, comprise an inductor current detector 403 which is configured to sample the inductor current I_{L}. However, the inductor current information may alternatively be received from a measurement module external to the SMPS 400.

In some embodiments, the controller 402 is configured to receive one or more measured values of the current flowing through the inductor element 101-4 of the voltage conversion circuit 101 before the scheduled change in the load current occurs, and determine, as the inductor current information, an average of the received one or more measured values. In other embodiments, the controller 402 may be configured to receive values indicative of a measured rate of change (with time) of the inductor current I_{L} flowing through the inductor element 101-4 before the scheduled change in the load current Iₒᵤₜ occurs, and to determine, as the inductor current information, an estimated value of the inductor current I_{L} by integrating at least some of the received values.

Using inductor current information to determine the duration of the current sourcing or sinking operation may allow the controller 402 to more effectively suppress voltage transients on Vₒᵤₜ caused by load current changes. In particular, by knowing the exact level of the inductor current I_{L}, the controller 402 can more accurately determine the start timing and duration of the sourcing or sinking operation for an upcoming load change.

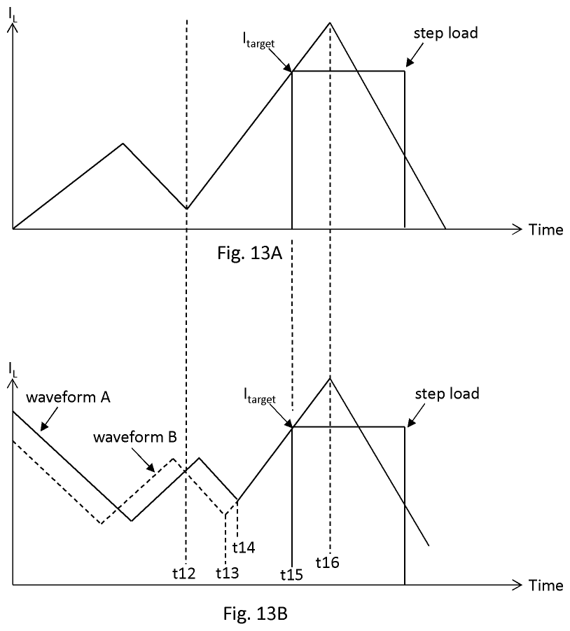

FIGS. 13A and 13B illustrate variations of the inductor current I_{L} over time for an embodiment which utilizes information indicating a value of the inductor current I_{L} before a scheduled change in the load current Iₒᵤₜ occurs, in order to determine the duration of the current sourcing or current sinking operation that is to be performed using the modified switching control signal S″_{SW}. The time axes in FIGS. 13A and 13B are identical.

The trace in FIG. 13A and trace A in FIG. 13B illustrate how, in relation to a load step that is to occur at a time instance, t15, the controller 402 is configured to control the voltage conversion circuit 101 (via switching element 101-2) to source current for different durations after determining different values of inductor current I_{L} at time t12. In this example, it is assumed that, prior to the sourcing operation occurring at time t12 for the trace in FIG. 13A, and prior to the sourcing operation occurring at t14 for trace A of FIG. 13B, the trace of FIG. 13A and trace A of FIG. 13B differ only in that trace A is a time-shifted version of the trace in FIG. 13A. In other words, it is assumed that, prior to the changes in the inductor current I_{L} caused by the current sourcing in the second mode of operation, the two traces (namely, the trace of FIG. 13A and trace A of FIG. 13B) both represent the variation of inductor current I_{L} during operation of the SMPS 400 in the first mode. Furthermore, the two traces are assumed to have identical peak-to-peak current ripples and average inductor current values, and that both traces result from switching of the switching element 101-2 at the same switching frequency and with the same duty cycle. However, due to the time offset between the two waveforms, it can be observed that the inductor current I_{L} at time instance t12 is different for the two traces.

In both the trace of FIG. 13A and trace A of FIG. 13B, the controller 402 determines, at time t12, that a scheduled rising load step will occur at time t15 based on the load scheduling information I_{LS}. However, in FIG. 13A, the value of the inductor current I_{L} at time t12 is the lower than the value of the inductor current I_{L} at the same time instance in trace A of FIG. 13B. Therefore, in order to source sufficient power to the load 120 to reduce or avoid an output voltage sag (which requires the SMPS 400 to raise the inductor current level as close as possible to the target current level defined by the load step), the controller 402 may be required to control the voltage conversion circuit 101 to source current earlier and for a longer duration than in the case of trace A in FIG. 13B. Thus, in FIG. 13A, the controller 402 immediately starts sourcing current to the load at time t12. In contrast, in FIG. 13B, trace A, the inductor current I_{L} is higher at time t12 (in comparison to the current level at t12 in FIG. A) and the controller 402 therefore delays starting the current sourcing operation until time t14, and sources current for a shorter period of time, from time t14 to time t16.

In some embodiments, the inductor current information is further indicative of whether the inductor current I_{L} flowing through the inductor element 101-4 before the scheduled change in the output current Iₒᵤₜ is increasing or decreasing. In these embodiments, in a case where the indication of the change in the load current Iₒᵤₜ indicates a scheduled decrease in the load current Iₒᵤₜ and the inductor current information indicates that the inductor current I_{L} flowing through the inductor element 101-4 before the scheduled decrease in the output current Iₒᵤₜ is increasing, the controller 402 is configured to determine the duration of the current sinking operation to be longer than in a case where the indication of the change in the load current Iₒᵤₜ indicates a scheduled decrease in the load current Iₒᵤₜ and the inductor current information indicates that the inductor current I_{L} flowing through the inductor element 101-4 before the scheduled decrease in the output current Iₒᵤₜ is decreasing. Furthermore, in a case where the indication of the change in the load current Iₒᵤₜ indicates a scheduled increase in the load current Iₒᵤₜ and the inductor current information indicates that the inductor current I_{L} flowing through the inductor element 101-4 before the scheduled increase in the output current Iₒᵤₜ is increasing, the controller 402 is configured to determine the duration of the current sourcing operation to be shorter than in a case where the indication of the change in the load current Iₒᵤₜ indicates a scheduled increase in the load current Iₒᵤₜ and the inductor current information indicates that the inductor current I_{L} flowing through the inductor element 101-4 before the scheduled increase in the output current Iₒᵤₜ is decreasing.

Trace A and Trace B of FIG. 13B illustrate the aforementioned embodiment where, in addition to determining an indication of a value of an inductor current I_{L} flowing through the inductor element 101-4, the controller 402 further determines, using the inductor current information, whether the inductor current I_{L} is increasing or decreasing before the scheduled change in the load current.

Referring to FIG. 13B, prior to the switch from operation in the first mode to operation in the second mode (occurring at time t13 for trace B and t14 for trace A), the inductor current waveform illustrated by trace B is a time-shifted version of the inductor current waveform illustrated by trace A. The time offset between the two waveforms is such that, at time 12, trace A and trace B have the same value of inductor current I_{L}. However, trace A at time t12 is coming to the end of an up-slope that corresponds to the increase in inductor current I_{L} when the switching element 101-2 is switched to the ON state during operation of the SMPS 400 in the first mode. Meanwhile, trace B at time t12 is an the onset of a down-slope that corresponds to the decrease in the inductor current I_{L} when the switching element 101-2 is in the OFF state during operation of the SMPS in the first mode. To reduce or prevent a voltage sag from occurring at time t15, the controller 402 is configured to delay starting to control the voltage conversion circuit 101 in the second mode, with a modified switching control signal S″_{SW} to source current to the load 120. The delay may allow the controller 402 to avoid causing too much current to be supplied to the load 120 when the load step occurs at time t15.

However, for trace B, in order to raise the inductor current I_{L} to the level of the load step at time t15, the controller 402 may control the SMPS 400 to start operating in the second mode to source current from time t13. In contrast, for trace A, the controller 402 may control the SMPS 400 to start operating in the second mode to source current from the later time t14, in order to increase the inductor current I_{L} to the level of the load step at time t15. Therefore, in the present example, the controller 402 controls the voltage conversion circuit 101 to starts sourcing current earlier and for a longer time period in the case of trace B as compared to the case of trace A. In this manner, in addition to using information indicative of a value of an inductor current I_{L} flowing through the inductor element 101-4, the controller 402 may further use information indicative of whether the inductor current I_{L} is increasing or decreasing before the scheduled change in the load current Iₒᵤₜ, in order to more precisely determine the duration for which the current sourcing or the current sinking should be performed.

The SMPS 400 may, as in the present embodiment, further comprise a voltage deviation detector 402-3, which is configured to monitor signals indicative of the supply voltage V_{Supply} of the load 120 and the output voltage Vₒᵤₜ of the SMPS 400, and to detect a positive deviation of the supply voltage V_{Supply} from the output voltage Vₒᵤₜ of the SMPS 400 by monitoring a voltage difference signal that is indicative of a voltage difference ΔV=V_{supply}−Vₒᵤₜ, and detecting there to be positive deviation of the supply voltage V_{Supply} from the output voltage Vₒᵤₜ when ΔV exceeds a positive predetermined threshold value for a supply voltage overshoot, ΔVₚₜ. The voltage deviation detector 402-3 is further configured to detect a negative deviation of the supply voltage from the output voltage Vₒᵤₜ when voltage difference ΔV indicated by the monitored voltage difference signal is smaller than a negative predetermined threshold value for a supply voltage undershoot, ΔVₙₜ.

The controller 402 is configured to respond to the voltage deviation detector 402-3 detecting the positive deviation of the supply voltage V_{supply} from the output voltage Vₒᵤₜ of the SMPS 400 by controlling the switching element 101-2 using a third control signal to cause the voltage conversion circuit 101 to provide a DC path from the input Tᵢₙ of the SMPS 400 to the output Tₒᵤₜ of the SMPS 400 until the voltage deviation detector 402-3 ceases to detect the positive deviation of the supply voltage V_{supply} from the output voltage Vₒᵤₜ of the SMPS 400 during its monitoring of the voltage difference signal and comparisons of the monitored signal with ΔVₚₜ. The controller 402 is configured to respond to the voltage deviation detector 402-3 detecting the negative deviation of the supply voltage V_{supply} from the output voltage Vₒᵤₜ of the SMPS 400 by controlling the switching element 101-2 using a fourth control signal to cause the voltage conversion circuit 101 to provide a DC path from the output Tₒᵤₜ of the SMPS 400 to ground until the voltage deviation detector 402-3 stops detecting the negative deviation of the supply voltage V_{supply} from the output voltage Vₒᵤₜ of the SMPS 400 during its monitoring of the voltage difference signal and comparisons of the monitored signal with ΔVₙₜ. The thresholds ΔVₚₜ and ΔVₙₜ may be adjustable in order to facilitate reconfiguration of the sourcing or sinking operation.

Accordingly, in this embodiment, when the voltage deviation ΔV exceeds the overshoot threshold value ΔVₚₜ, the controller 402 interrupts the switching in the first mode of operation (where the controller 402 switches the SMPS 400 to regulate its output voltage Vₒᵤₜ) and controls the SMPS 400 to sink current from the load 120 to counteract the overshoot, until the overshoot is suppressed. Conversely, when ΔV falls below the negative undershoot threshold value ΔVₙₜ, the controller 402 interrupts the first mode of operation and controls the SMPS 400 to sink current to counteract the overshoot, until the overshoot is suppressed. The voltage deviation detector 402-3 of the present embodiment may function to reduce or remove any voltage ripples which were not suppressed by the current sourcing or current sinking operations (using the modified switching control signal S″_{SW}) performed based on load scheduling information I_{LS}. To obtain accurate voltage deviation measurements, remote sensing of the supply voltage V_{supply} can be employed.

The SMPS 100 of the first embodiment or any of the described variants thereof may similarly be modified to include the voltage deviation detector 402-3 and the adaptation of the controller 402 described above to respond to the detection of voltage deviations by the voltage deviation detector 402-3.

In some embodiments, the voltage deviation detected by the voltage deviation detector 402-3 is further used by the controller 402 to adapt its modified switching operation, more specifically, the duration of the modified switching control signal S″_{SW} (for sourcing or sinking current based on load scheduling information I_{LS}) so that a voltage deviation caused by a load step can be more effectively suppressed when the a load step of substantially the same magnitude is determined again in the future. In particular, the voltage deviation measurements obtained can provide an indication of the effectiveness of a current sourcing or current sinking operation that was previously performed for a determined load step. Therefore, by feeding back any detected supply voltage deviations to the controller 402, the controller 402 can process this voltage deviation information using a machine learning algorithm and refine the duration of current sourcing or current sinking to be performed for a given load step.

For example, in an embodiment where the controller 402 controls the voltage conversion circuit 101 to perform current sourcing or current sinking in response to a scheduled load step determined using load scheduling information I_{LS}, if the controller 402 further detects a large supply voltage deviation (namely, a deviation that exceeds a positive threshold for a supply voltage overshoot, or a negative threshold for a supply voltage undershoot) occurring immediately after the scheduled load step has occurred, the controller 402 may be configured to adjust the duration of the current sourcing or current sinking operation to be performed when a load step of the same or similar size is determined again in the future. The amount of adjustment to be performed to the duration of the current sourcing or current sinking operation may be based on the amount by which the detected deviation in supply voltage V_{supply} exceeded the predetermined thresholds for triggering an automatic adjustment. For example, if a voltage deviation exceeding a predetermined overshoot or undershoot threshold is detected immediately after the controller 402 controlled the voltage conversion circuit 101 to source current in response to a determined rising load step, the controller 402 may be configured to increase the duration of the sourcing operation performed when a load step substantially the same in magnitude as the rising load step is determined again from subsequent load scheduling information I_{LS}. As the detected supply voltage deviation increases in magnitude, the amount by which the duration of the sourcing operation is increased may also be configured to increase.

In this manner, the controller 402 can be conveniently used with different PCB boards which exhibit different supply voltage deviations for a load step of the same size. Furthermore, the controller 402 in this embodiment does not require any reprogramming of its switching operations, and can automatically adapt its modified switching operations (i.e. the duration of sourcing and sinking) using feedback information on supply voltage deviations.

It should be noted that although Embodiments 1 and 2 are described using a buck conversion circuit comprising a single switching element 101-2 and a diode 101-3 for performing rectification, in some embodiments, the diode 101-3 may be replaced by a second switching element controlled by a second modified switching control signal provided by the controller 102, 402. The second modified switching control signal may be an inversion of the modified switching control signal S′_{SW}, S″_{SW} used to switch the first switching element 101-2, such that when the modified switching control signal S′_{SW}, S″_{SW} is HIGH, the second modified switching control signal is LOW, and vice versa. In this manner, the first switching element 101-2 and the second switching element are switched ON and OFF in an alternating manner. In such an embodiment, the controller 102, 402 is thus configured to control both switching elements simultaneously, allowing for synchronous or active rectification. The main advantage of synchronous rectification is that the voltage drop across the second switching element (namely, the rectification switching element) can be lower than the voltage drop across a rectification diode 101-3 in a nonsynchronous topology, and therefore the corresponding conduction loss is reduced. In some embodiments, to ensure safe operation, a “dead time” is configured to ensure that the first switching element 101-2 and the second switching element are never simultaneously ON. The “dead time” could thus be defined as the time delay between the falling edge of the modified switching control signal S′_{SW}, S″_{SW} of the first switching element 101-2 and the rising edge of the second modified switching control signal for switching the second switching element.

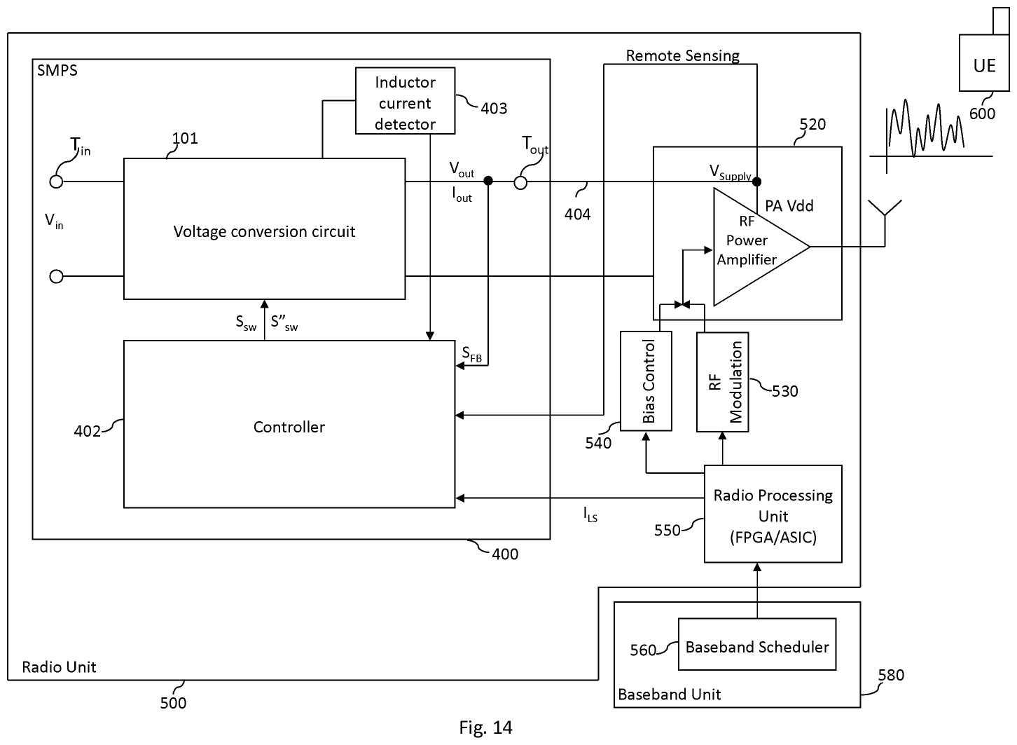

An application of the SMPS 400 according to the second embodiment to the field to telecommunications will now be described with reference to FIG. 14. In this example, the SMPS 400 is used to power a radio frequency (RF) power amplifier 520 in a radio unit 500 of a Long Term Evolution network (LTE) cellular network (although the power amplifier 520 may alternatively be provided in another component of the cellular network, such as a mobile terminal or an access point, for example. The SMPS 400 may be additionally or alternatively be compatible with RF power amplifiers in network devices that operate in accordance with other cellular standards, such as, for example, Global System for Mobile Communications (GSM) or 5G New Radio (NR).

In a network base station, such as a GSM base station, an LTE eNodeB, or a 5G NR gNodeB, the component that consumes the largest amount of power is often the RF power amplifier. A major cause of inefficiency in the RF power amplifier is voltage transients and voltage ringing that occur in the supply voltage of the RF power amplifier. These voltage transients may be caused by the slow response of the SMPS powering the RF power amplifier (inside the radio unit 500) to the rapid load changes in the radio traffic. Furthermore, in LTE, voltage transients can also be triggered by active adjustments of the bias voltage of the RF power amplifier, which is performed to put the amplifier into different power saving modes. In GSM, the voltage transients may be caused by adjustments to the supply voltage of the RF power amplifier.

Voltage transients in the supply voltage of an RF power amplifier can cause latency in the communication system by reducing the response speed of the RF power amplifier. In particular, to avoid deterioration of quality of service, QoS, symbols cannot be reliably transmitted until the amplifier supply voltage has stabilized. Moreover, voltage transients can also prevent the RF power amplifier from reacting quickly to dynamic power mode changes of the radio unit. Ringing in the RF power amplifier's supply voltage can prevent the RF power amplifier from entering power save mode quickly and cause additional power to be wasted.

Conventional methods for improving the efficiency of the RF power amplifier are based on envelope tracking to adjust the power converter output voltage. This method works by tracking the amplitude envelop of the RF signal and adjusting the power supply voltage applied to the RF power amplifier to closely match the required output voltage. In this manner, the RF power amplifier is always operated at peak efficiency as only the required power is provided. However, a major disadvantage of the envelope tracking method is that it is very slow and cannot respond quickly to remove voltage transients and ringing.

One way of stabilizing voltage transients and ringing at the RF power amplifier's supply voltage pin is to connect multiple SMPS converters in series so that the voltage transients occurring at the output of the SMPS may be smoothed out after the voltage step down operations of a subsequent SMPS. However, this method is highly inefficient in terms of power loss and circuit size.

The SMPS 400 of the present embodiment may effectively suppress voltage deviations in the RF power amplifier supply voltage, thus allowing the communication system to achieve higher energy efficiency while reducing transmission latency and reducing signal distortion caused by non-linearities in RF power amplifier performance.

Referring again to FIG. 14, the output terminal Tₒᵤₜ of the SMPS 400 is connected to the supply voltage input of the RF power amplifier 520 via power supply line 404, which may be provided in the form of a conductive tracing on a printed circuit board (PCB), for example.

An LTE baseband unit 580 generates a baseband OFDM signal, which is supplied, via a radio processing unit 550, to an RF modulation unit 530 that modulates an RF carrier signal with the OFDM baseband signal. A baseband scheduler 560 inside the baseband unit 580 schedules the data to be sent. The RF modulated signal is then input to the RF power amplifier 520. In the present example, an appropriate bias voltage is applied to the gate of the RF power amplifier 520 by a bias control circuit 540 to ensure that the RF power amplifier 520 operates in the correct mode to minimize output signal distortion due to signal clipping or undercutting.

In FIG. 14, the baseband scheduler 560 provides resource allocation information for forthcoming radio transmissions to the radio processing unit 550. The baseband scheduler 560 schedules radio resources to users based on QoS information and channel quality information. In LTE, the baseband scheduler 560 schedules radio resources several transmission time intervals (TTI) in advance of data transmission, where each TTI is one subframe (1 ms in duration) and represents the smallest scheduling time interval in which the baseband scheduler 560 is capable of scheduling any user. For 5G NR system, the TTI is variable and flexible numerology will apply, with smaller TTI durations than in LTE.

In the present embodiment, the radio processing unit 550, upon receiving resource allocation information, calculates or processes load scheduling information I_{LS} for the RF power amplifier 520. This load scheduling information I_{LS} comprises information indicative of a load current scheduled to be drawn from the SMPS 400 by the RF power amplifier 520 in a forthcoming TTI.

After calculating the load scheduling information I_{LS}, the radio processing unit 550 sends the load scheduling information I_{LS} comprising load current information for a scheduled, forthcoming TTI to the SMPS controller 402. The SMPS controller 402 therefore receives information on load current scheduled to be drawn by the RF power amplifier 520 during data transmission for a forthcoming TTI, at least one TTI before the data is transmitted by the RF power amplifier 520.

The load scheduling information provided to the SMPS controller 402 may take the form of any of the previously described examples and embodiments. In the present example, the SMPS controller 402 is further configured to use the load scheduling information I_{LS} for the at least one forthcoming TTI to determine a scheduled change in the load current Iₒᵤₜ. More specifically, in the present example, the controller 402 is configured to determine, as the indication of a change in the load current Iₒᵤₜ, a difference between a first value indicative of a load current I_{LS} that has been drawn from the SMPS 400 by the RF power amplifier 520 in a first TTI, and a second value comprised in the load scheduling information I_{LS}, the second value being indicative of a load current Iₒᵤₜ that is scheduled to be drawn from the SM PS 400 by the RF power amplifier 520 in a second TTI after the first TTI. The controller 402 is further configured to generate the modified switching control signal S″_{SW} using the determined difference, in accordance with any previous embodiments described.

In another example, the radio processing unit 550 directly determines information indicative of a scheduled change in the magnitude of the load current Iₒᵤₜ and provides this information as load scheduling information I_{LS} to the SMPS controller 402. In this manner, the SMPS controller 402 does not need to calculate the change in the load current Iₒᵤₜ and can generate a modified switching control signal S″_{SW} directly using the load scheduling information I_{LS}. Therefore, in this embodiment, it is radio processing unit 550, and not the SMPS controller 402, which is configured to determine, as the indication of a change in the load current Iₒᵤₜ, a difference between a first value indicative of a load current Iₒᵤₜ that has been drawn from the SMPS 400 by the RF power amplifier 520 in a first TTI, and a second value comprised in the load scheduling information I_{LS}, the second value being indicative of a load current Iₒᵤₜ that is scheduled to be drawn from the SMPS 400 by the RF power amplifier 520 in a second TTI after the first TTI.

For a 5G NR system, the minimum scheduling interval is one slot, and therefore, when the RF power amplifier 520 is used in a 5G system, 5G NR slot information providing power and time information on OFDM symbols in each 5G NR slot may be provided to the SMPS controller 402 ahead of time. The duration of a time slot in 5G NR system is variable and depends on the 5G numerology used, with each numerology corresponding to a different slot length and subcarrier spacing.

In GSM, the minimum time unit of transmission which can be allocated to a particular user is given by a GSM slot, which has a duration of approximately 0.577 ms. Therefore, when the RF power amplifier 520 is used with a GSM system, the load scheduling information I_{LS} may comprise information indicative of a load current scheduled to be drawn in from the RF power amplifier 520 during one or more GSM slots. In GSM systems, a constant envelop modulation is used, meaning that the peak to average power ratio (PAPR) of the baseband signal is 0 dB. However the transmission power of the transmitter is closed loop controlled and adjusted according to the received signal level or signal quality at the receiver. Accordingly, the GSM scheduler may also provide scheduling information in the form of GSM power control messages and parameters. These power control information can thus be sent to the SMPS controller 402 to form part of the load scheduling information I_{LS}.

Although LTE subframes, NR slots and GSM slots are described in the aforementioned examples, the skilled person will appreciate that the SMPS 400 can use other defined transmission time intervals to determining a scheduled change in the load current Iₒᵤₜ to be drawn by the RF power amplifier 520. In some embodiments, controller 402 is configured to monitor the duration of the scheduled transmission intervals and increase the operating switching frequency of the SMPS 400 in response to determining a decrease in the duration of one or more of the scheduled transmission intervals. For example, in a 5G NR system, when the numerology is increased (i.e. slot length is reduced), the SMPS controller 402 may be configured to correspondingly increase its switching frequency, so that the sourcing and sinking operation is adapted to react to more rapid load transients.

The SMPS controller 402 in FIG. 14 further comprises a voltage deviation detector 402-3 and an inductor current detector 403, which may be implemented as described above.

In FIG. 14, the RF power amplifier 520 may be put into different power level operating modes depending on the level of radio traffic. In particular, as the RF power amplifier 520 is implemented in an LTE system in the present example, power saving can be performed by adjusting the bias voltage of the RF power amplifier 520 in order to reduce DC power consumption when the radio traffic level is low. Furthermore in LTE, the high PAPR of OFDM symbols requires fast adaptation of the LTE RF power amplifier supply voltage in order to prevent signal peak clipping. In addition, in a GSM system, the RF power amplifier 520 can be put into different power saving modes by adjusting the supply voltage of RF power amplifier 520. As these operational mode changes of RF power amplifier directly affect the level of the load current drawn from the SMPS 400, the SMPS controller 402 can more accurately suppress SMPS output voltage deviations by obtaining information on these operational mode adjustments ahead of time and adapting the sourcing and sink operations of the SMPS 400 before these operational mode adjustments are implemented by the RF power amplifier 520.

Therefore, in the present embodiment, the controller 402 is further configured to determine an adjustment in a bias voltage of the RF power amplifier 520 which is scheduled to occur but has not yet occurred. Furthermore, the controller 402 is further configured to generate a modified switching control signal S″_{SW} using the determined adjustment in the bias voltage and to control the switching of the switching element 101-2 using the modified switching control signal S″_{SW} before the adjustment in the bias voltage occurs so as to suppress a voltage deviation in the output voltage Vₒᵤₜ or supply voltage V_{supply} caused by an adjustment of the bias voltage. In the example of FIG. 14, the radio processing unit 550 is configured to determine the bias voltage adjustment ahead of time by tracking the load of the RF power amplifier 520 and monitoring the bias voltage adjustment conditions to determine when the bias voltage needs to be adjusted. The radio processing unit 550 is further configured to send this information to the SMPS controller 402 ahead of time, before the scheduled bias voltage adjustment is implemented by the bias control circuit 540. The continuous monitoring of bias voltage adjustment conditions and the subsequent feedback to the bias control module 540 helps to maintain the QoS on the radio interface. However, by additionally feeding back this information to the SMPS controller 402, pre-compensation of the SMPS 400 can be performed to suppress output voltage transients caused by changes to the operating conditions of the RF power amplifier 520.

In addition, in FIG. 14, the SMPS controller 402 is further configured to determine an adjustment of a supply voltage V_{supply} of the RF power amplifier 520 which is scheduled to occur but has not yet occurred. The controller 540 is further configured to generate a modified switching control signal S″_{SW} using the determined adjustment of the supply voltage V_{supply} and to control the switching of the switching element 101-2 using the modified switching control signal S″_{SW} before the adjustment of the supply voltage V_{supply} occurs so as to suppress a voltage deviation in the output voltage Vₒᵤₜ or supply voltage V_{supply} caused by an adjustment in the supply voltage V_{supply}. In the present example, information indicating an upcoming supply voltage adjustment may be provided directly by the radio processing unit 550, which monitors the PAPR of OFDM symbols for forthcoming TTIs as well as past load conditions in order to determine whether the supply voltage V_{supply} should be adjusted or whether the RF power amplifier 520 should be put into power save mode.

In some embodiments where the SMPS 400 is used with an RF power amplifier 520, the load scheduling information I_{LS} may comprise an ENABLE signal for switching the RF power amplifier 520 from a lower power sleep mode to a high power operation mode. This ENABLE signal may be present in the communication system before the ENABLE signal is used to activate the RF power amplifier 520. Therefore, this ENABLE signal may be provided to the SMPS controller 402 as pre-information on an upcoming variation in the system operating conditions.

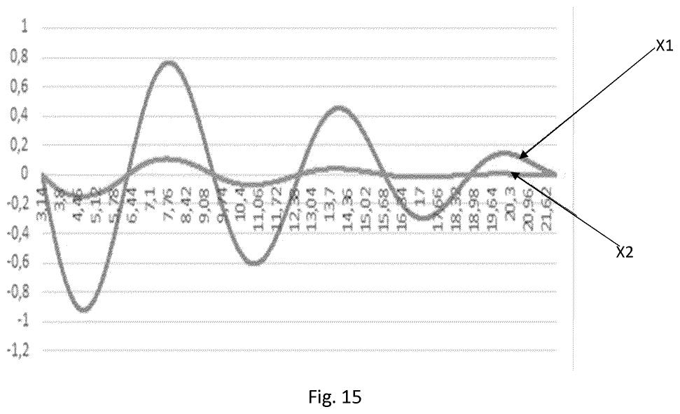

FIG. 15 shows simulation results comparing the supply voltage deviation of an RF power amplifier caused by a load transient in a case where the RF power amplifier is powered by a conventional SMPS, and in a case where the RF power amplifier is powered by an SMPS according to an embodiment. In FIG. 15, the larger ripple, X1, corresponds to the detected ringing of the supply voltage caused by a load step when the RF power amplifier is powered by a conventional SMPS. The smaller ripple, X2, corresponds to the detected supply voltage ripple when the same load step is applied to an RF power amplifier that is powered by an SMPS according to the embodiment. It can observed that, by controlling the SMPS using a modified switching control signal determined based on load scheduling information, the usually large voltage ripple in the supply voltage of the RF power 520 can be significantly reduced.

1. A switched mode power supply, SMPS, operable to supply an output voltage (Vₒᵤₜ) to a load, wherein an operating requirement of the load, comprising a load current (Iₒᵤₜ) drawn from the SMPS by the load or an operating voltage of the load, is scheduled to vary over time based on scheduling information (I_{LS}), the SMPS comprising:
a voltage conversion circuit having a switching element and configured to convert an input voltage (Vᵢₙ) applied to an input (Tᵢₙ) of the SMPS to the output voltage (Vₒᵤₜ) at an output (Tₒᵤₜ) of the SMPS by switching of the switching element the voltage conversion circuit further comprising a voltage divider comprising a feedback point between two resistors R1 and R2; and
a controller configured to generate a switching control signal (S_{SW}) based on a feedback signal (S_{FB}) which is obtained via the voltage divider and is indicative of the output voltage (Vₒᵤₜ), and to control the switching of the switching element using the switching control signal (S_{SW}) so as to regulate the output voltage (Vₒᵤₜ),
wherein the controller is further configured to generate a modified switching control signal (S′_{SW}) using an indication of a change in the operating requirement that is based on the scheduling information (I_{LS}), and using the feedback signal (S_{FB}) possible adjusted, and to control the switching of the switching element using the modified switching control signal (S′_{SW}) before the change in the operating requirement occurs so as to suppress a voltage transient in the output voltage (Vₒᵤₜ) caused by the change in the operating requirement.

2. The switched mode power supply according to claim 21, wherein the controller comprises:
an error signal generation module configured to generate an error signal (S_{Err}) based on a difference between a reference signal (V_{Ref}) and the feedback signal (S_{FB});
a feedback compensation module configured to generate a duty cycle control signal (S_{Duty}) by processing the error signal (S_{Err}) using a predetermined control law;
a switching signal generation module configured to generate the switching control signal (S_{SW}) based on the duty cycle control signal (S_{Duty}); and
wherein the signal adjustment module is further configured to adjust any of the reference signal (V_{Ref}), the error signal (S_{Err}) and the (S_{Duty}), based on the indication of the change in the operating requirement provided by the scheduling information (I_{LS}), so as to cause the switching signal generation module to generate the modified switching control signal (S′_{SW}) to control the switching of the switching element before the change in the operating requirement occurs in order to suppress the voltage transient in the output voltage (Vₒᵤₜ) of the SMPS caused by the change in the operating requirement.

3. The switched mode power supply according to claim 2, wherein:
in a case where the indication of the change in the operating requirement indicates a scheduled increase in the operating requirement, the switching signal adjustment module is configured to adjust the one or more of the reference signal (V_{Ref}), the feedback signal (S_{FB}), the error signal (S_{Err}) and the duty cycle control signal (S_{Duty}) so as to increase the switching duty cycle of the modified switching control signal (S′_{SW}) generated by the switching signal generation module; and
in a case where the indication of the change in the operating requirement indicates a scheduled decrease in the operating requirement, the switching signal adjustment module is configured to adjust the one or more of the reference signal (V_{Ref}), the feedback signal (S_{FB}), the error signal (S_{Err}) and the duty cycle control signal (S_{Duty}) so as to decrease the switching duty cycle of the modified switching control signal (S′_{SW}) generated by the switching signal generation module.

4. (canceled)

5. The switched mode power supply according to claim 21, wherein, in a case where the indication of the change in the operating requirement provided by the scheduling information (I_{LS}) comprises:
a scheduled step change in the operating requirement from a first value to a second value, the signal adjustment module is configured to generate:
a voltage pulse as the stimulus signal, and to determine at least one of a magnitude and a duration of the voltage pulse based on the indication of the step change in the operating requirement provided by the scheduling information (I_{LS}) such that the addition of the voltage pulse to the one or more of the reference signal (V_{Ref}), the feedback signal (S_{FB}), the error signal (S_{Err}) and the duty cycle control signal (S_{Duty}) causes the switching signal generation module to generate the modified switching control signal (S′_{SW}) to control the switching of the switching element before the step change in the operating requirement occurs to suppress the voltage transient in the output voltage (Vₒᵤₜ) caused by the step change in the operating requirement.

6. The switched mode power supply according to claim 21, wherein, in a case where the indication of the change in the operating requirement provided by the scheduling information (I_{LS}) comprises a plurality of changes in the operating requirement over time, the signal adjustment module is configured to generate, as the stimulus signal, a stimulus voltage having a voltage amplitude which varies over time, and to determine the variation of the amplitude of the voltage over time based on the indication of the scheduled changes in the operating requirement provided by the scheduling information (I_{LS}) such that the addition of the stimulus voltage to the one or more of the reference signal (V_{Ref}), the feedback signal (S_{FB}), the error signal (S_{Err}) and the duty cycle control signal (S_{Duty}) causes the switching signal generation module to generate the modified switching control signal (S′_{SW}) to control the switching of the switching element so as to suppress voltage transients in the output voltage (Vₒᵤₜ) caused by the changes in the operating requirement.

7. (canceled)

8. The switched mode power supply according to claim 1, wherein the controller is further configured to determine whether the indication of the change in the operating requirement provided by the scheduling information (I_{LS}) indicates a scheduled change in the operating requirement which exceeds a first predetermined threshold, and to generate the modified switching control signal (S′_{SW}) and control the switching of the switching element using the modified switching control signal (S′_{SW}) before the change in the operating requirement occurs when the indication of the change in the operating requirement provided by the scheduling information (I_{LS}) is determined to indicate a scheduled change in the operating requirement which exceeds the first predetermined threshold.

9. The switched mode power supply according to claim 1, wherein the switching element is configured to switch at a predetermined switching frequency and the controller is configured to:
in a case where the indication of the change in the operating requirement indicates a scheduled change in the operating requirement being a scheduled decrease in the operating requirement, interrupt the switching of the switching element at the predetermined switching frequency and generate, as the modified switching control signal (S″_{SW}), a first control signal which causes the voltage conversion circuit to provide a direct current, DC, path from the output (Tₒᵤₜ) of the SMPS to a current sink before the scheduled decrease in the operating requirement occurs and for a first period of time that is based on the indication of the scheduled decrease in the operating requirement, so as to suppress a voltage transient in the output voltage (Vₒᵤₜ) caused by the decrease in the operating requirement; and
in a case where the indication of the change in the operating requirement indicates a scheduled change in the operating requirement being a scheduled increase in the operating requirement, interrupt the switching of the switching element at the predetermined switching frequency and generate, as the modified switching control signal (S″_{SW}), a second control signal which causes the voltage conversion circuit to provide a DC path from the input (Tᵢₙ) of the SMPS to the output (Tₒᵤₜ) of the SMPS before the scheduled increase in the operating requirement occurs and for a second period of time that is based on the indication of the scheduled increase in the operating requirement, so as to suppress a voltage transient in the output voltage (Vₒᵤₜ) caused by the increase in the operating requirement.

10. The switched mode power supply according to claim 9, wherein:
the operating requirement of the load comprises the load current (Iₒᵤₜ) drawn from the SMPS by the load;
in the case where the indication of the change in the load current (Iₒᵤₜ) indicates a scheduled decrease in the load current (Iₒᵤₜ), the controller is configured to determine the first period of time based on the indication of the scheduled decrease in the load current (Iₒᵤₜ) and inductor current information that is indicative of a value of a inductor current (I_{L}) flowing through an inductor element of the SMPS before the scheduled decrease in the load current (Iₒᵤₜ) occurs, such that the first period of time increases with increasing size of the scheduled decrease in the load current lout and with increasing value of the current flowing through the inductor element of the SMPS; and
in the case where the indication of the change in the load current Iₒᵤₜ indicates a scheduled increase in the load current (Iₒᵤₜ), the controller is configured to determine the second period of time based on the indication of the scheduled increase in the load current (Iₒᵤₜ) and the inductor current information that is indicative of the value of the inductor current (I_{L}) flowing through the inductor element of the SMPS before the scheduled increase in the load current (Iₒᵤₜ) occurs, such that the second period of time increases with increasing size of the scheduled increase in the load current (Iₒᵤₜ) and with decreasing value of the current flowing through the inductor element of the SMPS.

11. The switched mode power supply according to claim 10, wherein the controller is configured to receive, as the inductor current information, one or more measured values of the inductor current (I_{L}) flowing through the inductor element of the SMPS before the scheduled change in the load current (Iₒᵤₜ) occurs.

12. The switched mode power supply according to claim 10, wherein the controller is further configured to receive one or more measured values of the inductor current (I_{L}) flowing through the inductor element of the SMPS before the scheduled change in the load current (Iₒᵤₜ) occurs and determine, as the inductor current information, an average of the received one or more measured values.

13. The switched mode power supply according to claim 10, wherein the controller is configured to receive values indicative of a measured rate of change of the inductor current (I_{L}) flowing through the inductor element of the SMPS before the scheduled change in the load current (Iₒᵤₜ) occurs, and to determine, as the inductor current information, an estimated value of the inductor current (I_{L}) by integrating at least some of the received values.

14. The switched mode power supply according to claim 10, wherein the inductor current information is further indicative of whether the inductor current (I_{L}) flowing through the inductor element before the scheduled change in the output current (Iₒᵤₜ) is increasing or decreasing, and wherein:
in a case where the indication of the change in the load current (Iₒᵤₜ) indicates a scheduled decrease in the load current (Iₒᵤₜ) and the inductor current information indicates that the inductor current (I_{L}) flowing through the inductor element before the scheduled decrease in the output current (Iₒᵤₜ) is increasing, the controller is configured to determine the first period of time to be longer than in a case where the indication of the change in the load current (Iₒᵤₜ) indicates a scheduled decrease in the load current (Iₒᵤₜ) and the inductor current information indicates that the inductor current (I_{L}) flowing through the inductor element before the scheduled decrease in the output current (Iₒᵤₜ) is decreasing; and
in a case where the indication of the change in the load current (Iₒᵤₜ) indicates a scheduled increase in the load current (Iₒᵤₜ) and the inductor current information indicates that the inductor current (I_{L}) flowing through the inductor element before the scheduled increase in the output current (Iₒᵤₜ) is increasing, the controller is configured to determine the second period of time to be shorter than in a case where the indication of the change in the load current (Iₒᵤₜ) indicates a scheduled increase in the load current (Iₒᵤₜ) and the inductor current information indicates that the inductor current (I_{L}) flowing through the inductor element before the scheduled increase in the output current (Iₒᵤₜ) is decreasing.

15. The switched mode power supply according to claim 1, wherein:
the SMPS is configured to provide the output voltage, hereinafter abbreviated to Vₒᵤₜ, to a conductor, which provides a supply voltage, hereinafter abbreviated to V_{supply}, to the load;
the SMPS further comprises a voltage deviation detector configured to detect:
a positive deviation of the supply voltage V_{supply} from the output voltage Vₒᵤₜ of the SMPS by monitoring a voltage difference signal that is indicative of a voltage difference V_{supply}−Vₒᵤₜ, and detecting there to be positive deviation of the supply voltage V_{supply} from the output voltage Vₒᵤₜ of the SMPS when the voltage difference indicated by the monitored voltage difference signal exceeds a first, positive predetermined threshold value; and
a negative deviation of the supply voltage V_{supply} from the output voltage Vₒᵤₜ of the SMPS by monitoring the voltage difference signal, and detecting there to be negative deviation of the supply voltage V_{supply} from the output voltage Vₒᵤₜ of the SMPS when voltage difference indicated by the monitored voltage difference signal is smaller a second, negative predetermined threshold value; and
the controller is further configured to:
in response to the voltage deviation detector detecting the positive deviation of the supply voltage V_{supply} from the output voltage Vₒᵤₜ of the SMPS, control the switching element using a third control signal to cause the voltage conversion circuit to provide a direct current, DC, path from the input (Tᵢₙ) of the SMPS to the output (Tₒᵤₜ) of the SMPS until the voltage deviation detector ceases to detect the positive deviation of the supply voltage V_{supply} from the output voltage Vₒᵤₜ of the SMPS; and
in response to the voltage deviation detector detecting the negative deviation of the supply voltage Vsupply from the output voltage Vout of the SMPS, control the switching element using a fourth control signal to cause the voltage conversion circuit to provide a DC path from the output (Tout) of the SMPS to a current sink until the voltage deviation detector ceases to detect the negative deviation of the supply voltage Vsupply from the output voltage Vout of the SMPS.

16. The switched mode power supply, SMPS according to claim 1, wherein the operating requirement of the load comprises the load current (Iₒᵤₜ) drawn from the SMPS by the load, the load comprises a radio frequency, RF, power amplifier, and the scheduling information (I_{LS}) comprises information indicative of a respective load current (Iₒᵤₜ) that is scheduled to be drawn, during each of one or more scheduled time intervals, from the SMPS by the RF power amplifier.

17. The switched mode power supply, SMPS, according to claim 1, wherein
the load comprises a radio frequency, RF, power amplifier,
the operating requirement of the load comprises, as the operating voltage, one of a bias voltage of the RF power amplifier or a supply voltage (V_{supply}) of the RF power amplifier, and
the scheduling information (I_{S}) comprises information indicative of a respective value of the operating voltage that is scheduled to be required by the RF amplifier during each of one or more scheduled time intervals.

18. The switched mode power supply, SMPS, according to claim 16, wherein the controller is configured to monitor the duration of the scheduled time intervals and increase the operating switching frequency of the SMPS in response to determining a decrease in the duration of one or more of the scheduled time intervals.

19. The switched mode power supply according to claim 16, wherein the controller is configured to determine, as the indication of a change in the load current (Iₒᵤₜ), a difference between:
a first value that is indicative of a load current (Iₒᵤₜ) that has been drawn from the SMPS by the RF power amplifier in a first scheduled time interval;
a second value comprised in the load scheduling information (I_{LS}), the second value being indicative of a load current (Iₒᵤₜ) that is scheduled to be drawn from the SMPS by the RF power amplifier in a second transmission interval after the first time interval, and
the controller is operable to generate the modified switching control signal (S″_{SW}) using the determined difference.

20. The switched mode power supply according to claim 16, wherein the one or more scheduled time intervals are one of:
one or more Global System for Mobile communications, GSM, slots;
one or more Long Term Evolution, LTE, transmission time intervals (TTI); or
one or more Fifth Generation New Radio, 5G NR, slots.

21. The switched mode power supply according to claim 1, wherein the controller comprises:
a signal adjustment module configured to adjust the feedback signal by generating and adding, preferably via a resistor, a stimulus signal at the feedback point of the voltage conversion unit based on the indication of the change in the operating requirement provided by the scheduling information (I_{LS}), so as to cause a switching signal generation module to generate the modified switching control signal (S′_{SW}) to control the switching of the switching element before the change in the operating requirement occurs in order to suppress the voltage transient in the output voltage (Vₒᵤₜ) of the SMPS caused by the change in the operating requirement.

22. The switched mode power supply according to claim 21, wherein the signal adjustment module comprises resistors and possible further switching elements and wherein the signal adjustment module is configured to generate a voltage pulse as the stimulus signal and to control the further switching elements to add a voltage pulse to the feedback signal.
